(19) United States
(12) Patent Application Publication
(10) Pub. No.: US 2024/0322144 A1
(43) Pub. Date: Sep. 26, 2024

(54) LITHIUM METAL BATTERY AND METHOD OF PREPARING THE SAME

(71) Applicant: Samsung SDI Co., Ltd., Yongin-si (KR)

(72) Inventors: Woojin Bae, Yongin-si (KR); Kanghee Lee, Yongin-si (KR); Jongseok Moon, Yongin-si (KR); Hyunsik Woo, Yongin-si (KR); Jongseok Park, Yongin-si (KR); Heemin Kim, Yongin-si (KR); Jinhwan Park, Yongin-si (KR)

(21) Appl. No.: 18/430,045

(22) Filed: Feb. 1, 2024

(30) Foreign Application Priority Data
Mar. 26, 2023 (KR) 10-2023-0039338
Jun. 23, 2023 (KR) 10-2023-0080988

(51) Int. Cl. H01M 4/38; H01M 4/02; H01M 4/04; H01M 4/36; H01M 4/583; H01M 4/62; H01M 10/0525

(52) U.S. Cl. CPC H01M 4/382; H01M 4/0404; H01M 4/364; H01M 4/583; H01M 4/623; H01M 4/626; H01M 10/0525; H01M 2004/027

(57) ABSTRACT

An anode for a lithium metal battery, a lithium metal battery including the same, and a method of applying or preparing the lithium metal battery are provided. The anode includes an anode current collector and a protective layer formed on the anode current collector. The anode may further include an anode active material layer provided between the anode current collector and the protective layer, or may be free of an anode active material layer. The protective layer may include a first polymer including a hydroxyl group and i) boric acid (H₃BO₃), ii) a hydrate of boron oxide (B₂O₃) and water, or iii) a combination thereof.

### CROSS-REFERENCE TO RELATED APPLICATIONS

The present application claims priority to and the benefit of Korean Patent Application No. 10-2023-0039338, filed on Mar. 26, 2023, and Korean Patent Application No. 10-2023-0080988, filed on Jun. 23, 2023, in the Korean Intellectual Property Office, the entire content of each of which is incorporated herein by reference.

### BACKGROUND

### 1. Field

According to one or more embodiments, the present disclosure relates to a lithium metal battery and a method of preparing the same.

### 2. Description of the Related Art

Lithium metal batteries currently commercially available mainly utilize a carbon-based anode active material such as graphite. Such carbon-based anode active materials have high stability in lithium ion batteries because there is no change in volume during charging and discharging. However, because their capacity is relatively small (low), anode active materials with higher capacity are required (or are desired).

As an anode active material, a lithium metal with a relatively higher theoretical capacity than that of a comparable carbon-based anode active material may be utilized.

Side reactions between a lithium metal and an electrolyte during charging and discharging give rise to formation of dendrites on a surface of the lithium metal, and the growth of dendrites cause a short circuit between a cathode and an anode, which may cause degradation in lifespan characteristics of the lithium metal battery including the lithium metal.

1 Thus, there is a need or desire for a design or method to improve the lifespan characteristics of a lithium metal battery including the lithium metal.

### SUMMARY

One or more aspects of embodiments are directed toward an anode for a lithium metal battery having a novel (e.g., new) structure.

One or more aspects of embodiments are directed toward a lithium metal battery including the anode having a novel (e.g., new) structure.

One or more aspects of embodiments are directed toward a method of applying or preparing the anode for a lithium metal battery having a novel (e.g., new) structure.

Additional aspects will be set forth in part in the description which follows and, in part, will be apparent from the description, or may be learned by practice of the presented embodiments of the present disclosure.

According to one or more embodiments, an anode for a lithium metal battery includes
an anode current collector, and
a protective layer formed on the anode current collector,
wherein the anode may further include an anode active material layer between the anode current collector and the protective layer, or the anode may be free of an (or any) anode active material layer (e.g., the anode may exclude the anode active material layer),
wherein the protective layer may include a first polymer including a hydroxyl group, and
i) boric acid (H₃BO₃), ii) a hydrate of boron oxide (B₂O₃) and water, or iii) a combination thereof.

According to one or more embodiments, a lithium metal battery includes a cathode,
the anode, and
an electrolyte provided between the cathode and the anode.

The electrolyte may be a liquid electrolyte, a solid electrolyte, a gel polymer electrolyte, or a combination thereof. The solid electrolyte may include an oxide-based solid electrolyte, a sulfide-based solid electrolyte, a polymer solid electrolyte, or a combination thereof, and the gel electrolyte may include a polymer gel electrolyte.

According to one or more embodiments, a method of applying or preparing a lithium metal battery includes applying or preparing an anode current collector,
applying or preparing a composition for forming a protective layer, followed by forming a protective layer by applying and drying the composition onto the anode current collector (e.g., to form the protective layer), the composition including a first polymer including a hydroxyl group, and i) boric acid (H₃BO₃), ii) a hydrate of boron oxide (B₂O₃) and water, or iii) a combination thereof;
applying or preparing an electrolyte,
applying or preparing a cathode, and
applying or preparing an assembly by stacking the anode current collector, the electrolyte, and the cathode (e.g., to manufacture the lithium metal battery).

### BRIEF DESCRIPTION OF THE DRAWINGS

The preceding and other aspects, features, and advantages of certain embodiments of the disclosure will be more apparent from the following description taken in conjunction with the accompanying drawings, in which:

FIG. 1A is a diagram for explaining an effect of boric acid in a protective layer of an anode for a lithium metal battery according to some embodiments of the present disclosure;

FIG. 1B is a diagram for explaining an effect of improving lithium (Li) ion transfer by B—O—B bonding in a protective layer of an anode for a lithium metal battery according to some embodiments of the present disclosure;

FIG. 2 is a diagram for explaining a laminated structure of a lithium metal battery according to some embodiments of the present disclosure;

FIG. 3 shows changes in capacity retention rates according to the number of cycles in lithium metal batteries of Example 1 and Comparative Example 1;

FIG. 4 shows changes in capacity according to the number of cycles in lithium metal batteries of Example 1 and Comparative Example 1;

FIG. 5 is a scanning electron microscope (SEM) image showing a protective layer laminated on an anode current collector in a lithium metal battery of Example 1;

FIG. 6A is an SEM image showing a state of an anode in a lithium metal battery of Example 1 after charging to state of charge (SoC) 100%, if (e.g., when) viewed in the diagonal direction;

FIG. 6B is a cross-sectional SEM image showing a state of an anode in a lithium metal battery of Example 1 after charging to SoC 100%;

FIG. 6C is a cross-sectional SEM image showing a state of an anode in a lithium metal battery of Example 1 after charging to SoC 100%;

FIG. 7 is a schematic diagram of a lithium metal battery according to some embodiments of the present disclosure;

FIG. 8 is a schematic diagram of a lithium metal battery according to other embodiments of the present disclosure; and

FIG. 9 is a schematic diagram of a lithium metal battery according to other embodiments of the present disclosure.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. As utilized herein, the term “and/or” includes any and all combinations of one or more of the associated listed items. Expressions such as “at least one of,” if (e.g., when) preceding a list of elements, modify the entire list of elements and do not modify the individual elements of the list.

The present disclosure described hereinbelow may have one or more suitable modifications and one or more suitable embodiments, example embodiments will be illustrated in the drawings and more fully described. The present disclosure may, however, should not be construed as limited to the example embodiments set forth herein, and rather, should be understood as covering all modifications, equivalents, or alternatives falling within the scope of the present disclosure.

The terms utilized herein is for the purpose of describing particular embodiments only, and is not intended to be limiting the present disclosure. An expression utilized in the singular encompasses the expression of the plural, unless it has a clearly different meaning in the context. It will be further understood that the terms “comprise,” “comprising,” “comprises,” “include,” “includes,” “including,” “have,” “having,” and/or “has,” if (e.g., when) utilized in this specification, specify the presence of stated features, regions, integers, steps, operations, elements, and/or components, but do not preclude the presence or addition of one or more other features, regions, integers, steps, operations, elements, components, and/or groups thereof. As utilized herein, “/” may be interpreted as “and”, or as “or” depending on the context.

As utilized herein, the phrase “combination thereof” refers to a mixture, laminate, composite, copolymer, alloy, blend, reaction product, and/or the like of the constituents.

As used herein, singular forms such as “a,” “an,” and “the” are intended to include the plural forms as well, unless the context clearly indicates otherwise.

As used herein, the terms “use,” “using,” and “used” may be considered synonymous with the terms “utilize,” “utilizing,” and “utilized,” respectively.

As used herein, expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In this context, “consisting essentially of” means that any additional components will not materially affect the chemical, physical, optical or electrical properties of the semiconductor film.

In the drawings, thicknesses may be magnified or exaggerated to clearly illustrate one or more suitable layers and regions. Like reference numbers may refer to like elements throughout, and duplicative descriptions thereof may not be provided the drawings and the following description. It will be understood that if (e.g., when) one element, layer, film, section, sheet, and/or the like is referred to as being “on” another element, it can be directly on the other element or intervening elements may be present therebetween. Although the terms “first,” “second,” and/or the like may be utilized herein to describe one or more suitable elements, these elements should not be limited by these terms. These terms are only utilized to distinguish one element from another element. In the present specification and drawings, components having substantially the same functional features are referred to the same reference numerals, and thus repeated descriptions will not be provided.

Further, in this specification, the phrase “on a plane,” or “plan view,” means viewing a target portion from the top, and the phrase “on a cross-section” means viewing a cross-section formed by vertically cutting a target portion from the side.

In present disclosure, “not include (or not including) a or any ‘component’”, “exclude (or excluding) a or any ‘component’”, “omit (or omitting) a or any ‘component’”, “‘component’-free”, and/or the like refers to that the “component” not being added, selected or utilized as a component or compound in the composition, but the “component” of less than a suitable amount may still be included due to other impurities and/or external factors.

### Definitions

As utilized herein, the term “particle diameter” of a particle refers to an average particle diameter if (e.g., when) the particle is spherical, and for a particle that is non-spherical, said term refers to an average major axis length of the particle. The particle diameter of the particles may be measured by utilizing a particle size analyzer (PSA), a transmission electron microscopic (TEM) image, or a scanning electron microscopic (SEM) image. The “particle diameter’ of the particles refers to, for example, an average particle diameter. The average particle diameter may be, for example, a median particle diameter (D50). The median particle diameter D50 is a particle size corresponding to a 50% cumulative volume calculated from particles having a small particle size in a particle size distribution measured by, for example, a laser diffraction method. The average particle diameter and average major axis length of particles may be measured utilizing a scanning electron microscope. If (e.g., when) the size of the particles is measured utilizing a scanning electron microscope, the size of the particles is determined by the average value of 30 or more randomly extracted particles of 1 μm or more excluding differentials. Also, depending on context, when particles are spherical, “diameter” indicates a particle diameter or an average particle diameter, and when the particles are non-spherical, the “diameter” indicates a major axis length or an average major axis length.

The term “metal” as utilized herein may include both (e.g., simultaneously) a metal and a metalloid, such as silicon and germanium, in an elemental state or an ionic state.

The term “alloy” as utilized herein may refer to a mixture of two or more metals.

The term “cathode active material” as utilized herein may refer to a cathode material capable of undergoing lithiation and delithiation.

The term “anode active material” as utilized herein may refer to an anode material capable of undergoing lithiation and delithiation.

The terms “lithiation” and “lithiate” as utilized herein may refer to a process of adding lithium to a cathode active material or an anode active material.

The terms “delithiation” and “delithiate” as utilized herein may refer to a process of removing lithium from a cathode active material or an anode active material.

The terms “charging” and “charge” as utilized herein may refer to a process of providing electrochemical energy to a battery.

The terms “discharging” and “discharge” as utilized herein may refer to a process of eliminating electrochemical energy from a battery.

The terms “cathode” and “positive electrode” as utilized herein may refer to an electrode in which electrochemical reduction and lithiation occur during a discharge process.

The terms “anode” and “anode” as utilized herein may refer to an electrode in which electrochemical oxidation and delithiation occur during a charge process.

Hereinafter, an anode for a lithium metal battery according to embodiments, a lithium metal battery including the anode, and a method of applying or preparing the anode will be described in more detail.

### Lithium Metal Battery

In some embodiments, an anodeless lithium metal battery may be a battery utilizing an anode current collector alone (i.e., without an anode active material layer). For example, the battery may be operated through a process in which lithium ions transferred from a cathode are precipitated on a surface of the anode current collector upon charging, and the lithium precipitated on the surface of the anode current collector dissolves again and intercalates into the cathode upon discharging.

In some embodiments, the anodeless lithium metal battery may have the advantages of maximizing or increasing the energy density per volume or weight of the battery because a lithium metal utilized as an anode active material and/or an anode active material layer is omitted. However, lithium metal precipitated during operation gives rise to growth of lithium dendrites due to a non-substantially uniform current crowding phenomenon during oxidation/reduction processes. Lithium dendrites may not only cause material loss of the lithium anode and reduce the capacity and lifespan of the battery, but may also cause a short circuit at an anode and/or a cathode and give rise to safety issues.

To solve these problems, a method of introducing a protective layer on (e.g., top of) an anode current collector may reduce side reactions by minimizing or reducing contact between lithium and an electrolyte solution, thereby minimizing or reducing exposure of the electrolyte solution to the electrode surface and creating a substantially uniform flow of lithium ions throughout the electrode.

An aspect of the present disclosure provides an anode for a lithium metal battery including: an anode current collector; and a protective layer provided on the anode current collector. In some embodiments, the anode may further include an anode active material layer between the anode current collector and the protective layer, or the anode may be free of an (or any) anode active material layer (e.g., the anode may exclude the anode active material layer). The protective layer may include a first polymer including a hydroxyl group, and i) boric acid (H₃BO₃), ii) a hydrate of boron oxide (B₂O₃) and water, or iii) a combination thereof (i.e., i) and ii)).

The anode may further include a lithium electrodeposition-inducing layer between the anode current collector and the protective layer.

The protective layer including the first polymer including a hydroxyl group, and i) boric acid (H₃BO₃), ii) a hydrate of boron oxide (B₂O₃) and water, or iii) a combination thereof may be significantly dense. Thus, as the density and strength increase, lithium ions may move freely and lithium ion transfer may be improved, thereby improving lithium electrodeposition characteristics. As a result, ion conductivity may be increased, thereby improving high-rate characteristics of a lithium metal battery including the anode. If (e.g., when) the protective layer is provided on the anode active material layer, side reactions between the anode active material layer and an electrolyte may be effectively blocked and suppressed or reduced.

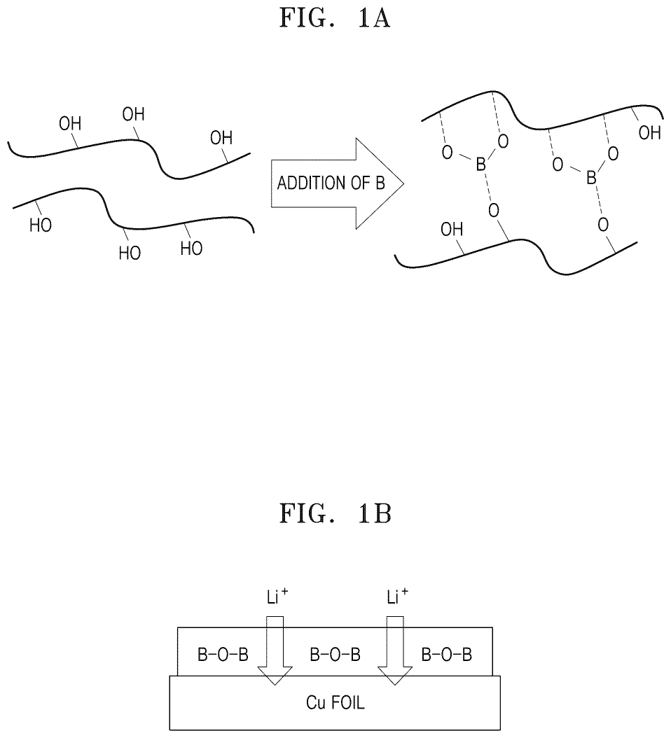

Referring to FIG. 1A, in formation of the protective layer, the first polymer including a hydroxyl group, and an additive including i) boric acid (H₃BO₃), ii) a hydrate of boron oxide (B₂O₃) and water, or iii) a combination thereof, may be utilized together so that hydrogen bonds may be formed between the first polymer and the additive.

If (e.g., when) a general cross-linking agent is added in the formation of the protective layer, a protective layer having increased physical properties of cross-linked products may be provided, but the movement of lithium ions may be partially hindered and the ion conductivity of the protective layer may be degraded accordingly.

However, the protective layer according to one or more embodiments of the present disclosure may include crosslinks formed between the first polymer including a hydroxyl group and a second polymer, and in this regard, the physical properties of the protective layer may be effectively improved without degrading the ion conductivity.

If (e.g., when) the protective layer includes cross-linked polymers formed by cross-linking the first polymer including a hydroxyl group and a second polymer, some of the first polymer including a hydroxyl group may remain so that the hydroxyl group of the first polymer may form hydrogen bonds with an additive such as boric acid. To allow some of the first polymer including a hydroxyl group to remain, a mixing ratio of the first polymer including a hydroxyl group to the second polymer may be adjusted. The mixing ratio of the first polymer including a hydroxyl group to the second polymer may be adjusted to be in a range of about 50:50 to about 99:1, about 50:50 to about 90:10, or about 60:40 to about 90:10.

As shown in FIG. 1B, if (e.g., when) the protective layer including boric acid is laminated on a copper foil serving as an anode current collector, the ability to transfer lithium ions may be improved.

If (e.g., when) the protective layer according to one or more embodiments is present on the surface of an anode active material layer including lithium metal, the formation and/or growth of lithium dendrites on the anode current collector may be effectively prevented or reduced. In this regard, the anode including the protective layer, and a lithium metal battery including the anode may have improved cycle characteristics and stability.

The first polymer including a hydroxyl group may include a polymerization product or a hydrolysate thereof, at least one of the polymerization product or the hydrolysate thereof including at least one monomer selected from among: carboxymethyl cellulose (CMC), polyvinyl alcohol (PVA), vinyl acetate, butyl (meta)acrylate, 2-hydroxyethyl (meta)acrylate, 2-hydroxypropyl (meta)acrylate, 4-hydroxybutyl (meta)acrylate, 6-hydroxyhexyl (meta) acrylate, 8-hydroxyoctyl (meta)acrylate, 2-hydroxyethyleneglycol (meta)acrylate, 2-hydroxypropyleneglycol (meta)acrylate, acrylic acid, methacrylic acid, 2-(meta)acryloyloxy acetic acid, 3-(meta)acryloyloxy propyl acid, 4-(meta)acryloyloxy butyl acid, itaconic acid, maleic acid, 2-isocyanatoethyl (meta)acrylate, 3-isocyanatopropyl (meta)acrylate, 4-isocyanatobutyl (meta)acrylate, (meta)acrylamide, ethylene di(meta)acrylate, diethylene glycol(meta)acrylate, triethyleneglycol di(meta)acrylate, trimethylenepropane tri(meta)acrylate, trimethylenepropanetriacrylate, 1,3-butandiol (meta)acrylate, 1,6-hexanediol di(meta)acrylate, allyl acrylate, and N-vinylcaprolactam.

The first polymer may be PVA. For example, PVA may be a hydrolysate obtained by hydrolyzing polyvinyl acetate with alkali.

The saponification degree of PVA may be in a range of about 60% to about 99%, about 70% to about 95%, about 75% to about 90%, or about 80% to about 90%. For example, the saponification degree of PVA may be in a range of about 85% to about 90%.

If (e.g., when) the saponification degree is within the ranges described, the physical properties of the protective layer may be further improved.

The weight average molecular weight of the first polymer may be in a range of about 10,000 Dalton to about 500,000 Dalton, about 10,000 Dalton to about 500,000 Dalton, about 10,000 Dalton to about 400,000 Dalton, about 10,000 Dalton to about 300,000 Dalton, about 10,000 Dalton to about 200,000 Dalton, about 50,000 Dalton to about 150,000 Dalton, about 70,000 Dalton to about 100,000 Dalton, or about 80,000 Dalton to about 100,000 Dalton. If (e.g., when) the weight average molecular weight of the first polymer is within the ranges described, the physical properties of the protective layer may be further improved.

The protective layer may further include the second polymer having a functional group crosslinkable with the first polymer including a hydroxyl group. The protective layer may further include a cross-linked polymer of the first polymer and the second polymer.

In the protective layer, an amount of the additive, i.e., i) boric acid (H₃BO₃), ii) a hydrate of boron oxide (B₂O₃) and water, or iii) a combination thereof, may be at most 5 wt %, or in a range of about 0.1 wt % to about 5 wt %, about 0.1 wt % to about 3 wt %, or about 0.1 wt % to about 2 wt %, based on 100 wt % of the total weight of the protective layer. If (e.g., when) the amount of the additive is within the ranges described, the physical properties, such as elastic modulus, of the protective layer may be increased by 20% or more. If (e.g., when) the amount of the additive exceeds 5 wt %, the crosslinking may proceed too quickly, making it difficult to apply in practice.

The second polymer may include at least one of a fluorinated polyamic acid and/or a fluorinated polyimide. The fluorinated polyamic acid and the fluorinated polyimide may each independently include a carboxyl group.

The fluorinated polyamic acid may be, for example, a polymer represented by Formula 1 or Formula 2, and the fluorinated polyimide may be, for example, a polymer represented by Formula 3 or Formula 4:

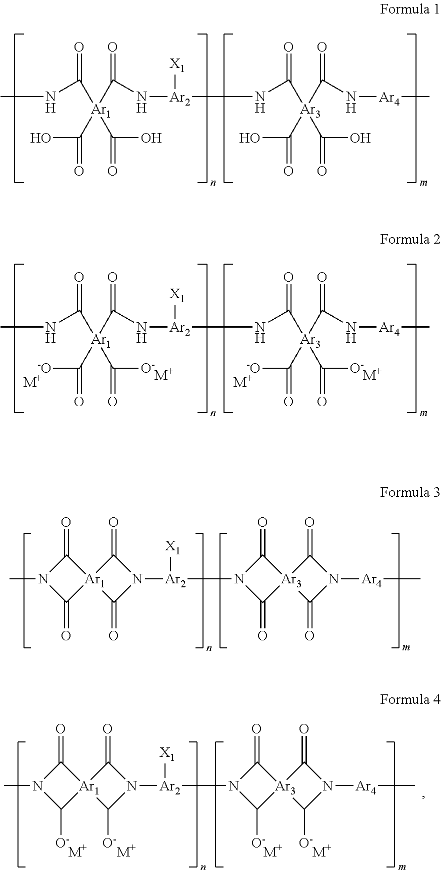

wherein, M may be alkali metal,
Ar₁ and Ar₃ may each independently be an aromatic cyclic group selected from among substituted or unsubstituted tetravalent C6-C24 arylene groups and substituted or unsubstituted tetravalent C4-C24 heteroarylene groups, wherein the aromatic cyclic group includes one aromatic ring, a fused ring of at least two aromatic rings, or at least two aromatic rings linked together via a single bond, —O—, —S—, —C(═O)—, —S(═O)₂—, —Si(Ra)(Rb)— (wherein Ra and Rb may each independently be a C1-C10 alkyl group), a substituted or unsubstituted C1-C10 alkylene group, or —C(═O)—NH—,
Ar₂ and Ar₄ may each independently be an aromatic cyclic group selected from among substituted or unsubstituted divalent C6-C24 arylene groups and substituted or unsubstituted divalent C4-C24 heteroarylene groups, wherein the aromatic cyclic group includes one aromatic ring, a fused ring of at least two aromatic rings, or at least two aromatic rings linked together via a single bond, —O—, —S—, —C(═O)—, —S(═O)₂—, —Si(Ra)(Rb)— (wherein Ra and Rb may each independently be a C1-C10 alkyl group), a substituted or unsubstituted C1-C10 alkylene group, or —C(═O)—NH—,
at least one of Ar₁ to Ar₄ may be substituted with a halogen group,
X₁ may be —COOH, —OH, —CO—NH₂, or —COH, as a first functional group, and
n and m may each indicate a mole fraction within a repeating unit and satisfy 0<n≤1, 0≤m<1, and n+m=1.

The halogen group may be a fluorine group, a chlorine group, a bromine group, or an iodine group. For example, the halogen group may be a fluorine group.

Ar₁ and Ar₃ may each independently be selected from Formulae 1a and 1b, and Ar₂ and Ar₄ may each independently be selected from Formulae 1c to 1e:

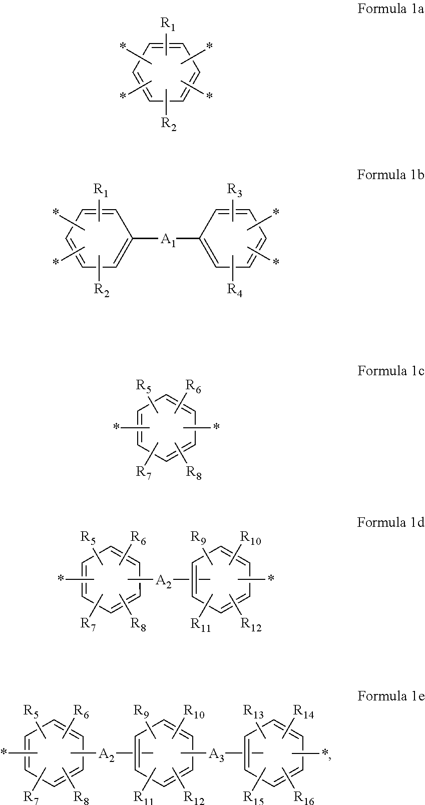

wherein, R₁, R₂, R₃, R₄, R₅, R₆, R₇, R₈, R₉, R₁₀, R₁₁, R₁₂, R₁₃, R₁₄, R₁₅, and R₁₆ may each independently be hydrogen, a halogen, —COOH, —OH, —CO—NH₂, —COH, a C1-C10 alkyl group unsubstituted or substituted with a halogen, a C6-C20 aryl group unsubstituted or substituted with a halogen, or a C2-C20 heteroaryl group unsubstituted or substituted with a halogen, wherein at least one of R₁ to R₁₆ may be a halogen group or a group substituted with a halogen group, A₁, A₂, and A₃ may each independently be a single bond, —O—, —C(═O)—, —S—, —S(═O)₂—, —Si(Ra)(Rb)— (wherein Ra and Rb may each independently be a C1-C10 alkyl group), a C1-C10 alkylene group unsubstituted or substituted with a halogen, or —C(═O)—NH—, and at least one of R₅ to R₁₆ in Formulae 1c to 1e that is selected for Ar₂ may be, as the first functional group, —COOH, —OH, —CO—NH₂, or —COH.

For example, in Formulae 1a to 1e, R₁ to R₁₆ may each independently be a hydrogen atom, a halogen atom, a hydroxyl group, —CH₃, or —CF₃, wherein, in Formulae 1c to 1e that is selected for Ar₂, at least one of R₅ to R₁₆ may be, as a first functional group, —COOH, —OH, —CO—NH₂, or —COH, and A₂ and A₃ may each independently be a single bond, —O—, —CO—, —S—, —SO₂—, —C(CH₃)₂—, —CONH—, —C(CF₃)₂—, —CH₂—, or —CF₂—.

The fluorinated polyamic acid may be, for example, a polymer represented by Formula 5 or Formula 6, and the fluorinated polyimide may be, for example, a polymer represented by Formula 7 or Formula 8:

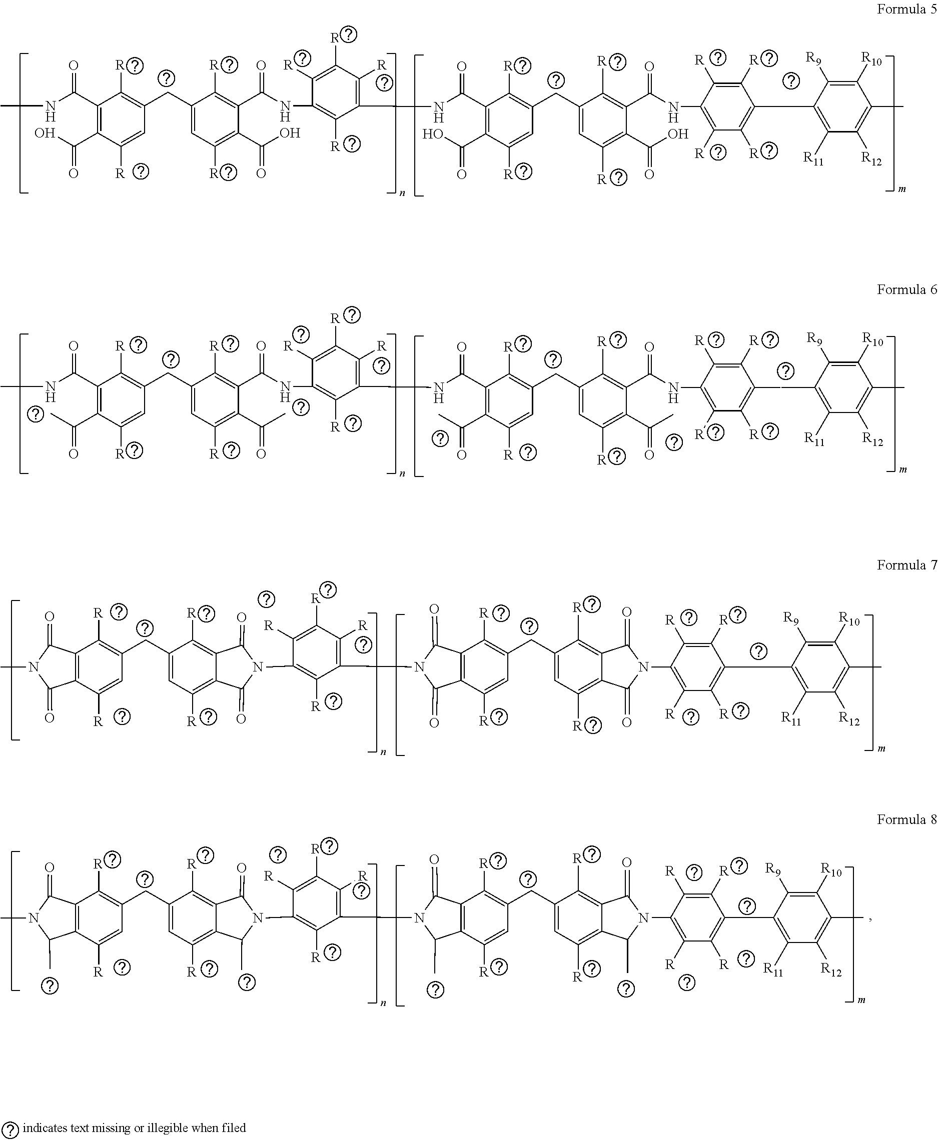

wherein, M may be lithium or sodium,
R₁, R₂, R₃, R₄, R₅, R₆, R₇, R₈, R₉, R₁₀, R₁₁, and R₁₂ may each independently be hydrogen, a halogen, —COOH, —OH, —CO—NH₂, —COH, a C1-C10 alkyl group unsubstituted or substituted with a halogen, a C6-C20 aryl group unsubstituted or substituted with a halogen, or a C6-C20 aryl group unsubstituted or substituted with a halogen, wherein at least one of R₁ to R₁₂ may be a halogen or a C1-C10 alkyl group, a C6-C20 aryl group, or a C6-C20 aryl group substituted with a halogen,

A₁ and A₂ may each independently be a single bond, —O—, —S—, —C(═O)—, —S(═O)₂—, —Si(Ra)(Rb)— (wherein Ra and Rb may each independently be a C1-C10 alkyl group), a C1-C10 alkylene group unsubstituted or substituted with a halogen group, or —C(═O)—NH—,
wherein at least one of R₅, R₆, R₇, or R₈ may be —COOH, —OH, —CO—NH₂, or —COH, and n and m may each indicate a mole fraction within a repeating unit and satisfy 0<n≤1, 0≤m<1, and n+m=1.

The halogen group may be a fluorine group, a chlorine group, a bromine group, or an iodine group. For example, the halogen group may be a fluorine group. Ar₁ and Ar₃ may each independently be selected from Formulae 1a and 1b, and Ar₂ and Ar₄ may each independently be selected from Formulae 1c to 1e.

The fluorinated polyamic acid may be, for example, a polymer represented by Formula 9 or Formula 10, and the fluorinated polyimide may be, for example, a polymer represented by Formula 11 or Formula 12:

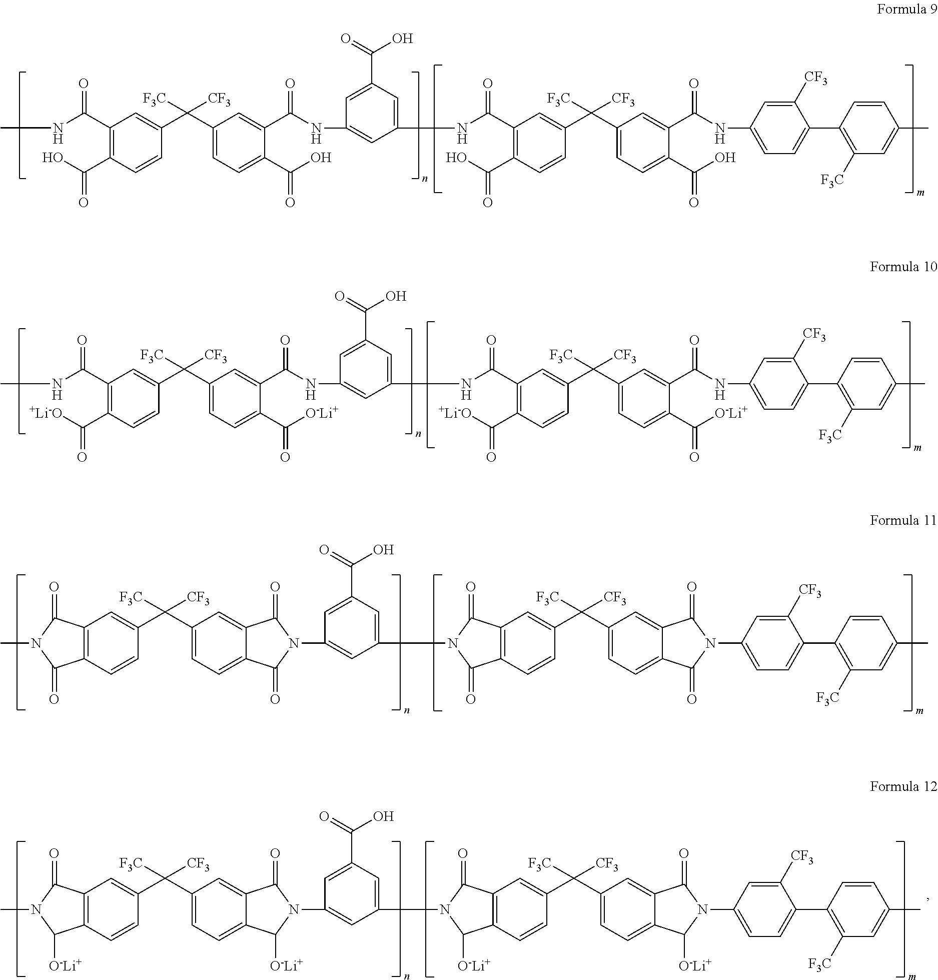

wherein, n and m each indicate a mole fraction within a repeating unit and satisfy 0<n≤1, 0≤m<1, and n+m=1.

For example, in the second polymer, mole fractions of a repeating unit including a cross-linking group and a repeating unit not including (e.g., excluding) a cross-linking group may each satisfy 0<n≤0.5, 0.5≤m<1, and n+m=1. For example, in the second polymer, mole fractions of a repeating unit including a cross-linking group and a repeating unit not including (e.g., excluding) a cross-linking group may each satisfy 0.1≤n≤0.4, 0.6≤m≤0.9, and n+m=1. For example, in the second polymer, mole fractions of a repeating unit including a cross-linking group and a repeating unit not including (e.g., excluding) a cross-linking group may each satisfy 0.15≤n≤0.35, 0.65≤m≤0.85, and n+m=1. For example, in the second polymer, mole fractions of a repeating unit including a cross-linking group and a repeating unit not including (e.g., excluding) a cross-linking group may each satisfy 0.2≤n≤0.3, 0.7≤m≤0.8, and n+m=1. If (e.g., when) the mole fraction is within the ranges described, further improved physical properties may be provided.

For example, the second polymer may be a random copolymer. For example, the second polymer may be a block-copolymer.

The weight average molecular weight of the second polymer may be in a range of about 10,000 Dalton to about 1,200,000 Dalton, about 10,000 Dalton to about 1,100,000 Dalton, about 10,000 Dalton to about 1,000,000 Dalton, about 10,000 Dalton to about 500,000 Dalton, about 100,000 Dalton to about 500,000 Dalton, about 100,000 Dalton to about 400,000 Dalton, for example, about 100,000 Dalton to about 300,000 Dalton. If (e.g., when) the weight average molecular weight of the first polymer is within the ranges described, the physical properties of the protective layer may be further improved.

In the protective layer, the weight ratio of the first polymer including a hydroxyl group to the second polymer may be in a range of about 99:1 to about 50:50, about 95:5 to about 55:45, about 95:5 to about 60:40, about 95:5 to about 65:35, or about 90:10 to about 70:30. If (e.g., when) the weight ratio of the first polymer to the second polymer is within the ranges described, the physical properties of the protective layer may be further improved.

The hydroxyl group of the first polymer and the carboxyl group of the second polymer may react with each other to form an ester bond, thereby forming a third polymer in which the first polymer and the second polymer are crosslinked. The formation of the third polymer may improve the stability of the protective layer, and a halogen group such as a fluorine functional group may improve the interfacial stability by degrading the formation of irreversible lithium inclusion.

The protective layer according to one or more embodiments may include, as a cross-linked polymer, a cross-linked polymer of a polyvinyl alcohol (e.g., the PVA) and a fluorinated polyamic acid. The fluorinated polyamic acid may be, for example, a polymer represented by Formula 9 or Formula 10.

In some embodiments, the cross-linked polymer of the protective layer may be a cross-linked polymer (PVA/PI-F) of the PVA and the fluorinated polyimide. The fluorinated polyimide may be a polymer represented by Formula 11 or Formula 12.

The protective layer may further include a lithium salt. In some embodiments, for example, at least one material selected from among LiSCN, LiN(CN)₂, LiClO₄, LiBF₄, LiASF₆, LiPF₆, LiCF₃SO₃, LiC(CF₃SO₂)₃, LiC(FSO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄) may be utilized as the lithium salt.

In the anode according to one or more embodiments, the anode active material layer may include a lithium metal foil, lithium metal powder, a lithium alloy foil, lithium alloy powder, and/or a combination thereof. In one or more embodiments, the lithium alloy foil and the lithium alloy powder may each include a lithium alloy that may include lithium and a first metal.

The anode active material layer may include: a carbon-based material; a mixture of a carbon-based material and one or more first metal; a composite of a carbon-based material and one or more first metal; or a combination thereof. For example, the carbon-based material may include amorphous carbon, and the amorphous carbon may have an average particle diameter in a range of about 10 nanometer (nm) to about 100 nm. The carbon-based material may include at least one of carbon black, carbon nanotubes, carbon nanofibers, fullerene, activated carbon, carbon fibers, or a combination thereof.

The first metal may include indium (In), silicon (Si), gallium (Ga), tin (Sn), aluminum (Al), Titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel (Ni), iron (Fe), cobalt (Co), chromium (Cr), cesium (Cs), sodium (Na), potassium (K), calcium (Ca), yttrium (Y), tantalum (Ta), hafnium (Hf), barium (Ba), vanadium (V), strontium (St), lanthanum (La), or a combination thereof.

In some embodiments, a lithium metal layer (e.g., a first lithium metal layer) may be additionally provided between the anode current collector and one side of the protective layer. In some embodiments, a (e.g., another) lithium metal layer (e.g., a second lithium metal layer) may be additionally provided on the other side (e.g., of the protective layer) facing oppositely away from the one side of the protective layer (i.e., an opposite side of the protective layer). In other words, the lithium metal layer(s) may be a surface of the protective layer that is not adjacent to the anode active material layer.

The thickness of the protective layer may be in a range of about 1 μm to about 10 μm, about 2 μm to about 8 μm, or about 3 μm to about 5 μm.

If (e.g., when) the thickness of the protective layer is within the ranges described, a lithium metal battery including the protective layer may have increased internal resistance, excellent or suitable energy density without decreasing energy density of the lithium metal battery, excellent or suitable high-rate characteristics, and improved lifespan characteristics.

Another aspect of the present disclosure provides a lithium metal battery including: a cathode; the anode according to one or more embodiments described herein; and an electrolyte provided between the cathode and the anode.

The electrolyte may be a liquid electrolyte, a solid electrolyte, a gel electrolyte, or a combination thereof. The electrolyte may be, for example, an organic electrolyte solution. The organic electrolyte solution may be, for example, applied or prepared by dissolving a lithium salt in an organic solvent.

The solid electrolyte may include an oxide-based solid electrolyte, a sulfide-based solid electrolyte, a polymer solid electrolyte, or a combination thereof. The gel electrolyte may be in a gel state without including a polymer.

The gel electrolyte may include a polymer gel electrolyte. The cathode may include a cathode current collector and a cathode active material layer, and at least one of the cathode current collector and/or the anode current collector may include a base film and a metal layer provided on at least one side, (e.g., on one side or both (e.g., opposite) sides) of the base film. The base film may include a polymer, and the polymer may include polyethylene terephthalate (PET), polyethylene (PE), polypropylene (PP), polybutylene terephthalate (PBT), polyimide (PI), or a combination thereof.

The metal layer may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

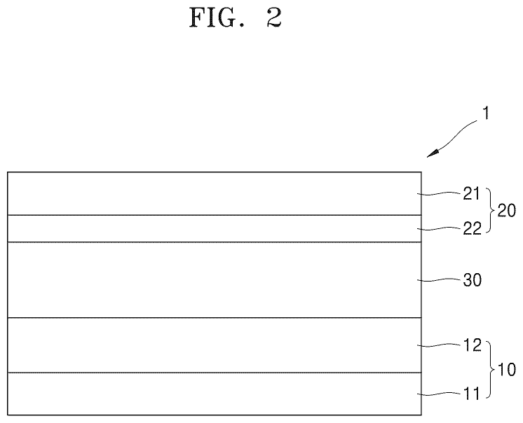

Referring to FIG. 2, a lithium metal battery 1 may include an anode 20 including an anode current collector 21, and may be free of an anode active material layer.

A protective layer 22 may be formed between the anode current collector 21 and an electrolyte 30.

A cathode 10 may be sequentially provided on the electrolyte 30. The cathode 10 may include a cathode active material layer 12 and a cathode current collector 11.

An anode active material layer may be additionally provided between the anode current collector 21 and the protective layer 22. The anode active material layer may include a lithium metal or a lithium alloy.

The lithium metal may include, for example, a lithium metal foil, a lithium alloy foil, or a combination thereof. The lithium metal may be in the form of powder (or in the form of particles), and such lithium powder (or lithium particles) may include lithium metal powder, lithium alloy powder, or a combination thereof. The lithium alloy may be an alloy of lithium with another metal alloyable with lithium, and may include, for example, a lithium-silver alloy, a lithium-zinc alloy, a lithium-magnesium alloy, a lithium-tin alloy, and/or the like. The anode active material layer including a lithium metal foil may be, for example, a lithium metal layer. The anode active material layer including a lithium alloy foil may be, for example, a lithium alloy layer. The anode active material layer including lithium metal powder and/or lithium alloy powder may be introduced by coating the anode current collector 21 with a slurry containing lithium powder and a binder. The binder may be, for example, a fluorine-based binder such as polyvinylidene fluoride (PVDF). The anode active material layer may be free of a carbon-based anode active material. In this regard, the anode active material layer may include (e.g., consist of) a metal-based anode active material.

The thickness of the lithium metal may be, for example, in a range of about 1 μm to about 50 μm, about 1 μm to about 30 μm, about 10 μm to about 30 μm, or about 10 μm to about 80 μm. If (e.g., when) the thickness of the lithium metal is within the ranges described, the lifespan characteristics of the lithium metal battery 1 including the protective layer 22 may be further improved. The particle diameter of the lithium powder (or lithium particles) may be, for example, in a range of about 0.1 μm to about 3 μm, about 0.1 μm to about 2 μm, or about 0.1 μm to about 2 μm. If (e.g., when) the particle diameter of the lithium powder is within the ranges described, the lifespan characteristics of the lithium metal battery 1 including the protective layer 22 may be further improved.

The thickness of the anode active material layer may be, for example, in a range of about 0.1 μm to about 500 μm, about 1 μm to about 500 μm, or about 10 μm to about 500 μm, but is not limited thereto. The thickness may be adjusted depending on the required type or kind, capacity, and/or the like of the lithium metal battery 1. If (e.g., when) the thickness of the anode active material layer is within the described ranges, the cycle characteristics of the lithium metal battery 1 may be improved without a decrease in the energy density thereof.

The lithium metal battery 1 according to embodiments may not include (e.g., may exclude) an anode active material layer between the anode current collector 21 and the protective layer 22. The anode 20 not including an anode active material layer may be introduced into the lithium metal battery 1 together with the cathode 10 and the electrolyte 30. By charging the lithium metal battery 1, the lithium metal may be plated between the anode current collector 21 and the protective layer 22, and this plated lithium metal may serve as an anode active material layer. In this regard, an anode active material layer may be a plated lithium layer.

The lithium metal battery 1 may further include a separator.

The separator may have a pore diameter generally in a range of about 0.01 μm to about 10 μm, and a thickness generally in a range of about 5 μm to about 20 μm. In one or more embodiments, examples of the separator, may include an olefin-based polymer such as polypropylene, or a sheet or non-woven fabric made of glass fiber or polyethylene may be utilized. If (e.g., when) a solid polymer electrolyte is utilized as the electrolyte, the solid polymer electrolyte may serve as a separator.

The olefin-based polymer to be utilized as the separator may include, for example, polyethylene, polypropylene, or a multi-layer film of two or more layers thereof, and examples of the multi-layer may include a two-layer separator of polyethylene/polypropylene, a three-layer separator of polyethylene/polypropylene/polyethylene, a three-layer separator of polypropylene/polyethylene/polypropylene, and/or the like.

In the lithium metal battery according to one or more embodiments, the liquid electrolyte may contain a lithium salt and an organic solvent.

The organic solvent may be, for example, an aprotic organic solvent such as N-methyl-2-pyrrolidone, propylene carbonate, ethylene carbonate, butylene carbonate, dimethyl carbonate, diethyl carbonate, gamma-butylolactone, 1,2-dimethoxy ethane, tetrahydroxy furan, 2-methyl tetrahydrofuran, dimethyl sulfoxide, 1,3-dioxolane, formamide, dimethyl formamide, acetonitrile, nitromethane, methyl formate, methyl acetate, phosphate triester, trimethoxy methane, a dioxolane derivative, sulfonale, methyl sulfonale, 1,3-dimethyl-2-imidazolidinone, a propylene carbonate derivative, a tetrahydrofuran derivative, ether, methyl propionate, ethyl propionate, and/or the like. Among the aforementioned examples, the carbonate-based solvent such as propylene carbonate, ethylene carbonate, butylene carbonate, dimethyl carbonate, diethyl carbonate, and/or the like may be utilized.

The lithium salt may be any lithium salt commonly utilized in lithium secondary batteries, and as a material easily dissolvable in the described nonaqueous solvents, may utilize at least one of materials such as LiSCN, LiN(CN)₂, LiClO₄, LiBF₄, LiAsF₆, LiPF₆, LiCF₃SO₃, LiC(CF₃SO₂)₃, LiC(FSO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂ and/or the like.

The concentration of the lithium salt in the liquid electrolyte may be, for example, in a range of about 1 M to about 5 M, for example, about 1 M to about 2.5 M. Within the ranges described, a sufficient amount of lithium ions required for charging and discharging of the lithium metal battery 1 may be generated.

If (e.g., when) the gel-type or kind polymer electrolyte is present in the pores of the porous substrate, the interfacial resistance between the cathode, the anode, and the separator may be minimized or reduced, thereby facilitating lithium transfer.

According to one or more embodiments, an anode active material layer may be provided at the time of assembling the lithium metal battery 1. According to other embodiments, an anode active material layer may be included due to a lithium metal being plated after charging. In this regard, the anode active material layer may be a plated lithium layer.

Such an anode active material layer may include a lithium metal or a lithium alloy.

If (e.g., when) the anode active material layer is provided at the time of assembly, a carbon-based material alone, or a combination of a carbon-based material and at least one of a metal and a metalloid may be included.

The carbon-based material may include amorphous carbon, wherein the amorphous carbon may have an average particle diameter in a range of about 10 nm to about 100 nm. The carbon-based material may include carbon black (CB), acetylene black (AB), furnace black (FB), Ketjen black (KB), graphene, or a combination thereof.

The anode material layer may include a lithium metal foil, lithium metal powder, a lithium alloy foil, lithium alloy powder, or a combination thereof. In some embodiments, the lithium alloy foil and the lithium alloy powder each may include a lithium alloy that may include lithium and a first metal.

The first metal may include indium (In), silicon (Si), gallium (Ga), tin (Sn), aluminum (Al), Titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel (Ni), iron (Fe), cobalt (Co), chromium (Cr), cesium (Cs), sodium (Na), potassium (K), calcium (Ca), yttrium (Y), bismuth (Bi), tantalum (Ta), hafnium (Hf), barium (Ba), vanadium (V), strontium (St), lanthanum (La), or a combination thereof.

For example, the anode active material layer may include a lithium foil, lithium powder, or a combination thereof. Examples of the lithium foil may include a lithium metal foil, a lithium alloy foil, or a combination thereof. The lithium metal may be in the form of powder, and lithium powder may include lithium metal powder, lithium alloy powder, or a combination thereof. The lithium alloy may be an alloy of lithium with another metal alloyable with lithium, and may include, for example, a lithium-silver alloy, a lithium-zinc alloy, a lithium-magnesium alloy, a lithium-tin alloy, and/or the like. The anode active material layer including a lithium metal foil may be, for example, a lithium metal layer. The anode active material layer including a lithium alloy foil may be, for example, a lithium alloy layer. The anode active material layer including lithium metal powder and/or lithium alloy powder may be introduced by coating the anode current collector 21 with a slurry containing lithium powder and a binder. The binder may be, for example, a fluorine-based binder such as polyvinylidene fluoride (PVDF). The anode active material layer may be free of a carbon-based anode active material. In this regard, the anode active material layer may include (e.g., consist of) a metal-based anode active material.

The anode current collector may be, for example, formed of a material that does not react with lithium, that is, a material that forms neither an alloy nor a compound with lithium. A material for forming the negative electrode current collector may be, for example, Cu, stainless steel, Ti, Fe, Co, Ni, and/or the like, but is not limited thereto. Any material available as an electrode current collector in the art may be utilized. The negative electrode current collector may be formed of one of the aforementioned metals, an alloy of two or more of the aforementioned metals, or a coating material. The negative electrode current collector may be, for example, in the form of a plate or foil.

In some embodiments, the cathode current collector may utilize, for example, a plate or a foil, each consisting of In, Cu, Mg, stainless steel, Ti, Fe, Co, Ni, and/or Zn, or a plate or foil made of aluminum (Al), germanium (Ge), lithium (Li) or an alloy thereof. The thickness of the cathode current collector 11 may be, for example, in a range of about 1 μm to about 100 μm, about 1 μm to about 50 μm, about 5 μm to about 25 μm, or about 10 μm to about 20 μm.

The anode active material layer may include an anode active material and a binder.

The anode active material may be, for example, in the form of particles. The particle diameter of the anode active material in the form of particles may be, for example, in a range of about 10 nm to about 4 μm, about 10 nm to about 1 μm, about 10 nm to about 500 nm, about 10 nm to about 100 nm, or about 20 nm to about 80 nm. If (e.g., when) the average particle diameter of the anode active material is within the ranges described, lithium may be more easily subjected to reversible plating and/or dissolution during charging and discharging. The average particle diameter of the anode active material may be, for example, a median diameter D50 measured by utilizing a laser particle size distribution meter.

The anode active material may include, for example, one or more selected from a carbon-based anode active material and a metal or metalloid anode active material. The carbon-based anode active material may be, for example, amorphous carbon. Examples of the amorphous carbon may include carbon black (CB), acetylene black (AB), furnace black (FB), Ketjen black (KB), graphene, and/or the like, but are not necessarily limited thereto. Any material categorized as amorphous carbon in the art may be utilized. The amorphous carbon may be carbon that has no or very low crystallinity, and in this regard, may be distinguished from crystalline carbon or graphite-based carbon. The metallic or metalloid anode active material may include at least one of Au, Pt, Pd, Au, Pt, Pd, Si, Ag, Al, Bi, Sn, and/or Zn, but is not necessarily limited thereto. Any material available as the metallic or metalloid anode active material capable of forming an alloy or compound with lithium in the art may be utilized. For example, Ni does not form an alloy with lithium, and thus Ni is not regarded as a metallic anode active material in the present specification. Among such anode active materials, the anode active material layer may include a single anode active material, or may include a mixture of a plurality of different anode active materials. The anode active material layer may include, for example, a mixture of amorphous carbon with at least one metal selected from among Au, Pt, Pd, Si, Ag, Al, Bi, Sn, and Zn. The mixing ratio of the mixture may be a weight ratio, and for example, may be in a range of about 10:1 to about 1:2, about 10:1 to about 1:1, about 7:1 to about 1:1, about 5:1 to about 1:1, or about 4:1 to about 2:1. The anode active material included in the anode active material layer may include, for example, a mixture of first particles consisting of amorphous carbon and second particles consisting of a metal or a metalloid. The metal may include, for example, Au, Pt, Pd, Si, Ag, Al, Bi, Sn, Zn, and/or the like. The amount of the second particle may be in a range of about 8 wt % to about 60 wt %, about 10 wt % to about 50 wt %, about 15 wt % to about 40 wt %, or about 20 wt % to about 30 wt %, based on the total weight of the mixture. If (e.g., when) the amount of the second particles is within the ranges described, for example, the cycle characteristics of the lithium metal battery 1 may be further improved.

Examples of the binder included in the anode active material layer may include a styrene butadiene rubber (SBR), polytetrafluoroethylene, polyvinylidene fluoride, polyethylene, a vinylidene fluoride/hexafluoropropylene copolymer, polyacrylonitrile, polymethylmethacrylate, and/or the like, but are not limited thereto. Any material available as the binder in the art may be utilized. The binder may be utilized alone or in a combination of a plurality of different binders. If (e.g., when) the anode active material layer does not include a binder, the anode active material layer may be easily detached from a ceramic coating layer or the anode current collector 21. The amount of the binder included in the anode active material layer may be, for example, in a range of about 1 wt % to about 20 wt % based on the total weight of the anode active material layer.

The thickness of the anode active material layer may be, for example, in a range of about 0.1 μm to about 500 μm or about 100 μm to about 50 μm. The thickness of the anode active material layer may be, for example, in a range of about 1% to about 50%, about 1% to about 30%, about 1% to about 10%, or about 1% to about 5%, of the thickness of a cathode active material layer. If (e.g., when) the thickness of the anode active material layer is excessively small (e.g., is too small or low), lithium dendrites formed between the anode active material layer and the anode current collector 21 may cause the anode active material layer to collapse, making it difficult to improve the cycle characteristics of the lithium metal battery 1. If (e.g., when) the thickness of the anode active material layer excessively increases (e.g., is too larger or high), the lithium metal battery 1 employing the anode 20 may suffer a decrease in the energy density, making it difficult to improve the cycle characteristics of the lithium metal battery 1.

If (e.g., when) the thickness of the anode active material layer decreases, for example, the charge capacity of the anode active material layer may also decrease. The charge capacity of the anode active material layer may be, for example, in a range of about 0.1% to about 50%, about 1% to about 30%, about 1% to about 10%, about 1% to about 5%, or about 1% to about 2%, based on the charge capacity. If (e.g., when) the charge capacity of the anode active material layer is excessively small (e.g., is too small or low), lithium dendrites formed between the anode active material layer and the anode current collector 21 may cause the anode active material layer to collapse, making it difficult to improve the cycle characteristics of the lithium metal battery 1. If (e.g., when) the charge capacity of the anode active material layer excessively increases (e.g., is too larger or high), the lithium metal battery 1 employing the anode 20 may suffer a decrease in the energy density, making it difficult to improve the cycle characteristics of the lithium metal battery 1. The charge capacity of the cathode active material layer 12 may be obtained by multiplying the charge capacity density (milliampere hour (mAh/g)) of the cathode active material by the mass of the cathode active material in the cathode active material layer 12. If (e.g., when) several types (kinds) of the cathode active material are utilized, for each cathode active material, the charge capacity density may be multiplied by the mass, and the sum of these values may be the charge capacity of the cathode active material layer 12. The charge capacity of the negative electrode active material layer may be calculated in substantially the same way. The charge capacity of the anode active material layer may be obtained by multiplying the charge capacity density (mAh/g) of the anode active material by the mass of the anode active material in the anode active material layer. If (e.g., when) several types (kinds) of the anode active material are utilized, for each anode active material, the charge capacity density may be multiplied by the mass, and the sum of these values may be the charge capacity of the anode active material layer. Here, the charge capacity densities of the positive electrode active material and the negative electrode active material are capacities estimated by utilizing an all-solid half-cell utilizing lithium metal as a counter electrode. By the measurement of charging capacity utilizing a solid-state half-cell, charging capacities of the cathode active material layer and the anode active material layer may be directly measured. If (e.g., when) the measured charge capacity is divided by the mass of each active material, the charge capacity density may be obtained. In some embodiments, the charge capacities of the cathode active material layer 12 and the anode active material layer may be initial charge capacity measured during charging at the first cycle.

### Lithium Metal Battery

A lithium metal battery according to embodiments may include: a cathode; an anode; and an electrolyte between the cathode and the anode. The lithium metal battery may further include a separator. Such a lithium metal battery may provide excellent or suitable lifespan characteristics concurrently (e.g., simultaneously). For example, the lithium metal battery may be a lithium primary battery, a lithium secondary battery, a lithium-sulfur battery, a lithium-air battery, and/or the like, but is not limited thereto. Any lithium metal battery available in the art may be utilized.

The lithium metal battery may be, for example, applied or prepared according to the following method, but the preparation method thereof is not limited thereto, and may be adjusted according to required conditions.

### Cathode

First, a cathode active material composition may be applied or prepared by mixing a cathode active material, a conductive material, a binder, and/or a solvent. The applied or prepared cathode active material composition may be directly applied onto an aluminum current collector, and dried to prepare a cathode plate having a cathode active material layer formed thereon. In some embodiments, the cathode active material composition may be cast on a separate support, and then a film obtained by peeling off from the support may be laminated onto the aluminum current collector to prepare a cathode plate having a cathode active material layer formed thereon.

As the positive electrode active material, any material available as the lithium-containing metal oxide in the art may be utilized. For example, at least one composite oxide of lithium and also a metal selected from among Co, Mn, Ni, and a combination thereof may be utilized. For example, the positive electrode active material may be a compound represented by at least one selected from among the following formulae: LiₐA₁-2 (where 0.90≤a≤1 and 0≤b≤0.5); LiₐE_{1-b}B_{b}O_{2-c}D_{c} (where 0.90≤a≤1, 0≤b≤0.5, and 0≤c≤0.05); LiE_{2-b}B_{b}O_{4-c}D_{c} (where 0≤b≤0.5 and 0≤c≤0.05); LiₐNi_{1-b-c}CO_{b}B_{c}Dₐ (where 0.90≤a≤1, 0≤b≤0.5, 0≤c≤0.05, and 0<α≤2); LiₐNi_{1-b-c}Co_{b}B_{c}O_{2-α}F_{α} (where 0.90≤a≥1, 0≤b≥0.5, 0≤c≤0.05, and 0<α≤2); LiₐNi_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b≤0.5, 0≤c≤0.05, and 0<α≤2); LiₐNi_{1-b-c}Mn_{b}B_{c}O_{2-α}F_{α} (where 0.90≤a≤1, 0≤b≤0.5, 0≤c≤0.05, and 0<α<2); LiₐNi_{1-b-c}Mn_{b}B_{c}O_{2-α}F₂ (where 0.90≤a≤1, 0≤b≤0.5, 0≤c≤0.05, and 0<α<2); LiₐNi_{b}E_{c}G_{d}O₂ (where 0.90≤a≤1, 0≤b≥0.9, 0≤c≤0.5, and 0.001≤d≤0.1); LiₐNi_{b}Co_{c}Mn_{d}GeO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.1); LiₐMn₂G_{b}O₄ (where 0.90≤a≤1 and 0.001≤b≤0.1); QO₂; QS₂; LiQS₂; V₂O₅; LiV₂O₅; LiIO₂; LiNiVO₄; Li_{(3-f)}J₂(PO₄)₃ (were 0≤f≤2); Li_{(3-f)}Fe₂(PO₄)₃ (0≤f≤2); and/or LiFePO₄.

In the preceding formulae representing the compound, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof. A compound in which a coating layer is additionally provided on the surface of the aforementioned compound may be also utilized, and a mixture of the aforementioned compound and a compound additionally provided with a coating layer may be also utilized. The coating layer provided on the surface of the compound may include, for example, a coating element compound, such as an oxide of a coating element, hydroxide of a coating element, oxyhydroxide of a coating element, oxycarbonate of a coating element, or hydroxycarbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming the coating layer may be selected within a range that does not adversely affect the physical properties of the positive electrode active material. The coating method may be, for example, spray coating, dipping method, and/or the like. A detailed description of the coating method will not be provided because it may be well understood by those skilled in the art.

For example, the cathode active material may be LiₐNiₓCo_{y}M_{z}O_{2-b}A_{b} (where 1.0≤a≤1.2, 0≤b≤0.2, 0.8≤x<1, 0<y≤0.3, 0<z≤0.3, and x+y+z=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B) or a combination thereof, and A is F, S, Cl, Br, or a combination thereof), LiNiₓCo_{y}Mn_{z}O₂ (where 0.8≤x≤0.95, 0≤y≤0.2, 0<z≤0.2, and x+y+Z=1), LiNiₓCo_{y}Al_{z}O₂ (where 0.8≤x≤0.95, 0≤y≤0.2, 0<z≤0.2, and x+y+z=1), LiNiₓCo_{y}Mn_{z}Al_{w}O₂ (where 0.8≤x≤0.95, 0≤y≤0.2, 0<z≤0.2, 0<w≤0.2, and x+y+z+w=1), LiₐCoₓM_{y}O_{2-b}A_{b} (where 1.0≤a≤1.2, 0≤b≤0.2, 0.9≤x≤1, 0≤y≤0.1, and x+y=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof), LiₐNiₓMn_{y}M′_{z}O_{2-b}A_{b} (where 1.0≤a≤1.2, 0≤b≤0.2, 0<x≤0.3, 0.5≤y<1, 0<z≤0.3, and x+y+z=1, M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof), LiₐM1ₓM2_{y}PO_{4-b}X_{b} (where 0.90≤a≤1.1, 0≤x≤0.9, 0≤y≤0.5, 0.9<x+y<1.1, and 0≤b≤2, M1 may be chromium (Cr), manganese (Mn), iron (Fe), cobalt (Co), nickel (Ni), copper (Cu), zirconium (Zr), or a combination thereof, and M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X may be O, F, S, P or a combination thereof), or LiₐM3_{z}PO₄ (where 0.90≤a≤1.1 and 0.9≤z≤1.1, and M3 may be chromium (Cr), manganese (Mn), iron (Fe), cobalt (Co), nickel (Ni), copper (Cu), zirconium (Zr), or a combination thereof).

Examples of the conductive material may be: carbon black, graphite particulates, natural graphite, artificial graphite, acetylene black, Ketjen black, carbon fibers; carbon nanotubes; metallic powder, metallic fiber, or metallic tube of copper, nickel, aluminum, silver, and/or the like; and a conductive polymer such as a polyphenylene derivative. However, embodiments are not limited thereto, and any suitable conductive material available in the art may be utilized. In some embodiments, the cathode may not include (e.g., may exclude), for example, a separate conductive material.

Examples of the binder are a vinylidene fluoride/hexafluoropropylene copolymer, polyvinylidene fluoride, polyacrylonitrile, polymethyl methacrylate, polytetrafluoroethylene (PTFE), a mixture of the aforementioned polymers, a styrene butadiene-rubber polymer, and/or the like, and examples of the solvent are N-methyl pyrrolidone (NMP), acetone, water, and/or the like. However, embodiments are not limited thereto, and any suitable binder and solvent available in the art may be utilized.

A plasticizer or a pore-forming agent may be added to the cathode active material composition to form pores in an electrode plate.

The amount of each of the cathode active material, the conductive material, the binder, and the solvent utilized in the cathode may be at a level commonly utilized in a lithium battery. Depending on the intended utilize and composition of the lithium metal battery, one or more of the conductive material, the binder, and the solvent may not be provided.

The amount of the binder included in the cathode may be about 0.1 wt % to about 10 wt %, or about 0.1 wt % to about 5 wt %, relative to the total weight of the cathode active material layer. The amount of the cathode active material included in the cathode may be about 80 wt % to about 99 wt %, about 90 wt % to about 99 wt %, or about 95 wt % to about 99 wt %, with respect to the total weight of the cathode active material layer.

The cathode current collector may utilize, for example, a plate or a foil, each including (e.g., consisting of) In, Cu, Mg, stainless steel, Ti, Fe, Co, Ni, and/or Zn, a plate or foil made of aluminum (Al), germanium (Ge), lithium (Li) and/or an alloy thereof. The thickness of the cathode current collector 11 may be, for example, in a range of about 1 μm to about 100 μm, about 1 μm to about 50 μm, about 5 μm to about 25 μm, or about 10 μm to about 20 μm.

The cathode current collector 11 may include, for example, a base film and a metal layer provided on at least one surface (e.g., one or both (e.g., opposite) surfaces or sides) of the base film. The base film may include, for example, a polymer. The polymer may be, for example, a thermoplastic polymer. The polymer may include, for example, PET, PE, PP, PBT, PI, or a combination thereof. The base film may be, for example, an insulator. If (e.g., when) the base film includes an insulating thermoplastic polymer, the base film may be softened or liquified upon the occurrence of a short circuit, so that the operation of a battery may stop and a rapid increase in current may then be suppressed or reduced. The metal layer may include, for example, In, Cu, Mg, stainless steel, Ti, Fe, Co, Ni, Zn, Al, Ge, and/or an alloy thereof. The metal layer may act as an electrochemical fuse, and thus may be cut in the event of an overcurrent to perform a short circuit prevention function. By adjusting the thickness of the metal layer, a limit current and a maximum current may be adjusted. The metal layer may be plated or deposited on the base film. If (e.g., when) the thickness of the metal layer decreases, the limit current and/or the maximum current of the cathode current collector 11 may decrease, thereby improving the stability of the lithium metal battery 1. A lead tab may be added on the metal layer for the connection with the outside. The lead tab may be welded to the metal layer or a laminate of metal layer/base film by ultrasonic welding, laser welding, spot welding, and/or the like. The metal layer may be electrically connected to the lead tab while the base film and/or the metal layer melts during welding. A metal chip may be added between the metal layer and the lead tab for stronger welding therebetween. The metal chip may be a thin piece of the same material as the metal in the metal layer. The metal chip may be, for example, a metal foil or a metal mesh. The metal chip may be, for example, an Al foil, a Cu foil, or an SUS foil. By welding the lead tab after disposing the metal chip on the metal layer, the lead tab may be welded to a laminate of metal chip/metal layer or a laminate of metal chip/metal layer/base film. During the welding, the metal layer or the laminate of metal layer/metal chip may melt so that the metal layer and/or the laminate of metal layer/metal chip may be electrically connected to the lead tab. The metal chip and/or the lead tab may be added to a portion on the metal layer. The thickness of the base film may be, for example, in a range of about 1 μm to about 50 μm, about 1.5 μm to about 50 μm, about 1.5 μm to about 40 μm, or about 1 μm to about 30 μm. If (e.g., when) the thickness of the base film is within the ranges described, the weight of an electrode assembly may be reduced more effectively. The melting point of the base film may be, for example, in a range of about 100° C. to about 300° C., about 100° C. to about 250° C., or about 100° C. to about 200° C. If (e.g., when) the melting point of the base film is within the ranges described, the base film may be melted and easily connected to the lead tab in the process of welding the lead tab. To improve the adhesion between the base film and the metal layer, a surface treatment such as a corona treatment may be performed on the base film. The thickness of the metal layer may be, for example, in a range of about 0.01 μm to about 3 μm, about 0.1 μm to about 3 μm, about 0.1 μm to about 2 μm, or about 0.1 μm to about μm. If (e.g., when) the thickness of the metal layer is within the ranges described, the stability of an electrode assembly may be secured while maintaining the conductive. The thickness of the metal chip may be, for example, in a range of about 2 μm to about 10 μm, about 2 μm to about 7 μm, or about 4 μm to about 6 μm. If (e.g., when) the thickness of the metal chip is within the ranges described, the connection between the metal layer and the lead tab may be performed more easily. If (e.g., when) the cathode current collector 11 has the aforementioned structure, the weight of the cathode 10 may be reduced, and consequently, the energy density of the cathode 10 and the lithium metal battery 1 may be improved.

### Electrolyte

Next, the electrolyte may be applied or prepared. The electrolyte may be, for example, a liquid electrolyte, a solid electrolyte, a gel electrolyte, or a combination thereof. The electrolyte may be, for example, an organic electrolyte solution. The organic electrolyte solution may be, for example, applied or prepared by dissolving a lithium salt in an organic solvent.

For the organic solvent, any material available as an organic solvent in the related art may be utilized). Examples of the organic solvent may include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyl tetrahydrofuran, γ-butyrolactone, dioxolan, 4-methyl dioxolan, N, N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethyl ether, or a mixture thereof. organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethylether, and/or a mixture thereof.

For the lithium salt, any material available as a lithium salt in the related art may be utilized. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where 1≤x≤20 and 1≤y≤20), LiCl, LiI, and/or a mixture thereof. The concentration of the lithium salt may be, for example, about 0.1 M to about 5.0 M.

The solid electrolyte may include, for example, an oxide-based solid electrolyte, a sulfide-based solid electrolyte, and a polymer solid electrolyte, or a combination thereof.

The solid electrolyte may be, for example, an oxide-based solid electrolyte. The oxide-based solid electrolyte may include at least one selected from among Li_{1+x+y}AlₓTi₂₋ₓSi_{y}P_{3-y}O₁₂ (where 0<x<2 and 0≤y<3), BaTiO₃, Pb(Zr,Ti)O₃(PZT), Pb₁₋ₓLaₓZr_{1-y} Ti_{y}O₃ (PLZT) (where 0<x<1 and 0<y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1 and 0≤y≤1), LiₓLa_{y} TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M may be Te, Nb, or Zr, and x may be an integer from 1 to 10). The solid electrolyte may be applied or prepared by a sintering method and/or the like. For example, the oxide-based solid electrolyte may include a garnet-type or kind solid electrolyte selected from Li₇La₃Zr₂O₁₂ (LLZO) and Li₃₊ₓLa₃Zr₂₋ₐMₐO₁₂ (M-doped LLZO) (where M may be Ga, W, Nb, Ta, or Al, and x may be an integer from 1 to 10).

The sulfide-based solid electrolyte may include, for example, lithium sulfide, silicon sulfide, phosphorus sulfide, boron sulfide, or a combination thereof. Particles of the sulfide-based solid electrolyte may include Li₂S, P₂S₅, SiS₂, GeS₂, B₂S₃, or a combination thereof. The particles of the sulfide-based solid electrolyte particles may include Li₂S or P₂S₅. The particles of the sulfide-based solid electrolyte particles are suitable to have higher lithium ionic conductivity than other inorganic compounds. For example, the sulfide-based solid electrolyte may include Li₂S and P₂S₅. If (e.g., when) the sulfide solid electrolyte material constituting the sulfide-based solid electrolyte includes Li₂S—P₂S₅, a mixing molar ratio of Li₂S to P₂S₅ may be, for example, in a range of about 50:50 to about 90:10. In some embodiments, an inorganic solid electrolyte applied or prepared by adding Li₃PO₄, halogen, halogen compounds, Li₂₊₂ₓZn₁₋ₓGeO₄ (“LISICON”, 0≤x<1), Li_{3+y}PO^{4-x}Nₓ (“LIPON”, 0<x<4, 0<y<3), Li_{3.25}Ge_{0.25}P_{0.75}S₄ (“ThioLISICON”), Li₂O—Al₂O₃—TiO₂—P₂O₅ (“LATP”), and/or the like to an inorganic solid electrolyte of Li₂S—P₂S₅, SiS₂, GeS₂, B₂S₃, or a combination thereof, may be utilized as a sulfide solid electrolyte. Non-limiting examples of the sulfide solid electrolyte material are: Li₂S—P₂S₅; Li₂S—P₂S₅—LiX (where X may be a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where 0<m<10, 0<n<10, and Z may be Ge, Zn, or Ga); Li₂S—GeS₂; Li₂S—SiS₂—Li₃PO₄; and Li₂S—SiS₂—LiₚMO_{q} (where 0<p<10, 0<q<10, and M may be P, Si, Ge, B, Al, Ga, or In). In this regard, the sulfide-based solid electrolyte material may be applied or prepared by treating raw starting materials of the sulfide-based solid electrolyte material (e.g., Li₂S, P₂S₅, and/or the like) by a melt quenching method, a mechanical milling method, and/or the like. In some embodiments, a calcination process may be performed after the treatment. The sulfide-based solid electrolyte may be amorphous or crystalline, or may be in a mixed state.

The polymer solid electrolyte may include, for example, a mixture of a lithium salt and a polymer or a polymer including an ion-conducting functional group. The polymer solid electrolyte may be, for example, in a solid state at 25° C. and at 1 atm. The polymer solid electrolyte may not include (e.g., may exclude) liquid. The polymer of the polymer solid electrolyte may include, for example, polyethylene oxide (PEO), polyvinylidene fluoride (PVDF), vinylidene fluoride-hexafluoropropylene (PVDF-HFP), polyethylene oxide (PEO), a poly(styrene-b-ethylene oxide) block-copolymer (PS-PEO), poly(styrene-butadiene), poly(styrene-isoprene-styrene), a poly(styrene-b-divinylbenzene) block-copolymer, a poly(styrene-ethylene oxide-styrene) block-copolymer, polystyrene sulfonate (PSS), polyvinyl fluoride (PVF), poly(methylmethacrylate) (PMMA), polyethylene glycol(PEG), polyacrylonitrile (PAN), polytetrafluoro ethylene (PTFE), polyethylene dioxythiophene (PEDOT), polypyrrole (PPY), polyacrylonitrile (PAN), polyaniline, polyacetylene, nafion, aquivion, flemion, gore, aciplex, morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)] (SPBIBI), poly(styrene sulfonate) (PSS), lithium 9,10-diphenylanthracene-2-sulfonate (DPASLi+), or a combination thereof, but embodiments are not limited thereto. Any material available as a polymer electrolyte in the related art may be utilized. For the lithium salt, any material available as a lithium salt in the related art may be utilized. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(where x and y may each be between 1 to 20), LiCl, LiI, or a mixture thereof. The polymer included in the polymer solid electrolyte may be, for example, a compound including 10 or more, 20 or more, 50 or more, or 100 or more repeating units. The polymer included in the polymer solid electrolyte may have a weight average molecular weight of, for example, 1,000 Dalton (Da) or more, 10,000 Da or more, 100,000 Da or more, or 1,000,000 Da or more.

The gel electrolyte may be, for example, a polymer gel electrolyte. The gel electrolyte may be in a gel state without including a polymer.

The polymer gel electrolyte may include, for example, a liquid electrolyte and a polymer, or an organic solvent and a polymer having an ion-conductive functional group. The polymer solid electrolyte may be, for example, in a solid state at 25° C. and at 1 atm. The polymer gel electrolyte may be, for example, in a gel state without including liquid. The liquid electrolyte utilized in the polymer gel electrolyte may be, for example, a mixture of ionic liquid, a lithium salt, and an organic solvent; a mixture of a lithium salt and an organic solvent; a mixture of ionic liquid and an organic solvent; or a mixture of a lithium salt, ionic liquid, and an organic solvent. The polymer utilized in the polymer gel electrolyte may be selected from polymers utilized in the polymer solid electrolyte. The organic solvent may be selected from organic solvents utilized in liquid electrolytes. The lithium salt may be selected from lithium salts utilized in polymer solid electrolytes. The ionic liquid may refer to a salt in a liquid state, and a molten salt at room temperature consisting solely of ions and having a melting point room temperature. The ionic liquid may include, for example, at least one compound including a) at least one cation selected from among ammonium, pyrrolidinium, pyridinium, pyrimidium, imidazolium, piperidinium, pyrazolium, oxazolium, pyridazinium, phosphonium, sulfonium, triazolium, and any mixture thereof, and b) at least one anion selected from among BF₄⁻, PF₆⁻, AsF₆⁻, SbF₆⁻, AlCl₄⁻, HSO₄⁻, ClO₄⁻, CH₃SO₃⁻, CF₃CO₂, Cl⁻, Br⁻, I⁻, SO₄²⁻, CF₃SO₃⁻, (FSO₂)₂N⁻, (C₂F₂SO₂)₂N⁻, (C₂F₂SO₂)(CF₂SO₂)N⁻, and (CF₂SO₂)₂N⁻. The polymer solid electrolyte may be impregnated with a liquid electrolyte in a secondary battery to form a polymer gel electrolyte. The polymer gel electrolyte may further include inorganic particles. The polymer included in the polymer gel electrolyte may be, for example, a compound including 10 or more, 20 or more, 50 or more, or 100 or more repeating units. The polymer included in the polymer gel electrolyte may have a weight average molecular weight of, for example, 500 Da or more, 1,000 Da or more, 10,000 Da or more, 100,000 Da or more, or 1,000,000 Da or more.

### Anode

The anode may include an anode current collector.

In one or more embodiments, the anode current collector 21 may include, for example, a base film and a metal layer provided on at least one surface (e.g., one surface or both (e.g., opposite) sides or surfaces) of the base film. The base film may include, for example, a polymer. The polymer may be, for example, a thermoplastic polymer. The polymer may include, for example, PET, PE, PP, PBT, PI, or a combination thereof. The polymer may be an insulating polymer. If (e.g., when) the base film includes an insulating thermoplastic polymer, the base film may be softened or liquified upon the occurrence of a short circuit, so that the operation of a battery may stop and a rapid increase in current may then be suppressed or reduced. The metal layer may include, for example, Cu, stainless steel, Ti, Fe, Co, Ni, or an alloy thereof. The metal layer may correspond to, for example, a first metal substrate. The metal layer may further include a coating layer including a second metal. The anode current collector 21 may further include a metal chip and/or a lead tab. Details on the base film, the metal layer, the metal chip, and the lead tab of the anode current collector 21 may be understood by referring to the aforementioned cathode current collector. If (e.g., when) the anode current collector 11 has such a structure, the weight of the anode 20 may be reduced, and consequently, the energy density of the anode 20 and a lithium battery may be improved.

An anode active material layer may be formed on the anode current collector. The anode active material layer may be formed as a lithium plated layer after charging. In some embodiments, the anode active material layer may be formed by utilizing an anode active material during the battery assembly.

A process of applying or preparing the anode active material layer by utilizing an anode active material may be the same as the process of applying or preparing the cathode active material layer, except that an anode active material is utilized instead of a cathode active material in forming the cathode active material layer.

The lithium metal battery may further include, for example, a thin film including an element capable of forming an alloy with lithium on one surface of the anode current collector. The thin film may be provided between the anode current collector and the anode active material layer. The thin film may include, for example, an element capable of forming an alloy with Li. The element capable of forming an alloy with lithium may include, for example, Au, Ag, Zn, Ti, In, Si, Al, Bi, and/or the like, but is not necessarily limited thereto. Any material available as the element capable of forming an alloy with lithium in the art may be utilized. The thin film may be formed of one of these metals or an alloy of several types (kinds) of metals. Due to the thin film provided on one surface of the anode current collector, for example, the plated form of a first anode active material layer plated between the thin film and the anode active material layer may be further flattened, thereby further improving the cycle characteristics of the lithium metal battery.

### Separator

The lithium metal battery may further include a separator between the cathode and the anode.

For the separator, any separator commonly utilized in lithium metal batteries may be utilized. For the separator, for example, a separator exhibiting low resistance to the movement of ions in the electrolyte and excellent or suitable electrolyte solution-retaining ability may be utilized. For example, the separator may be in the form of non-woven fabric or woven fabric, each being formed of a material selected from glass fiber, polyester, Teflon, polyethylene, polypropylene, polytetrafluoroethylene (PTFE), or a combination thereof. For example, in a lithium ion battery, a rollable separator formed of polyethylene, polypropylene, and/or the like, may be utilized, and in a lithium ion polymer battery, a separator having excellent or suitable organic electrolyte solution-retaining ability may be utilized.

The separator may be, for example, applied or prepared according to the following example method, but the preparation method thereof is not limited thereto, and may be adjusted according to required conditions.

First, a separator composition may be applied or prepared by mixing a polymer resin, a filler, and a solvent. The separator composition may be directly applied onto an electrode, and then dried, so as to form a separator. In some embodiments, after casting a support with the separator composition and drying it, a separator film peeled off from the support may be laminated onto an electrode, so as to prepare a separator.

The polymer utilized in the separator preparation is not limited to any particular polymer and may utilize any polymer available for utilize in a binder of an electrode plate. For example, a vinylidene fluoride/hexafluoropropylene copolymer, polyvinylidene fluoride (PVDF), polyacrylonitrile, polymethyl methacrylate, or a mixture thereof may be utilized.

The separator may include a liquid electrolyte, and the liquid electrolyte may be applied or prepared by, for example, dissolving a lithium salt in an organic solvent.

For the organic solvent, any material available as an organic solvent in the related art may be utilized. Examples of the organic solvent may include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyl tetrahydrofuran, γ-butyrolactone, dioxolan, 4-methyl dioxolan, N, N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethyl ether, or a mixture thereof. organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethylether, or one or more mixtures thereof.

For the lithium salt, any material available as a lithium salt in the related art may be utilized. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where 1≤x≤20 and 1≤y≤20), LiCl, LiI, or one or more mixtures thereof. The concentration of the lithium salt may be, for example, about 0.1 M to about 5.0 M.

The lithium metal battery according to one or more embodiments may further include a solid electrolyte. Examples of the solid electrolyte may include an oxide-based solid electrolyte, a sulfide-based solid electrolyte, or a combination thereof.

The solid electrolyte may be, for example, an oxide-based solid electrolyte. The oxide-based solid electrolyte may include at least one of Li_{1+x+y}AlₓTi₂₋ₓSi_{y}P_{3-y}O₁₂ (where 0<x<2 and 0≤y<3), Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(Al, Ga)x(Ti, Ge)₂₋ₓSi_{y}P_{3-y}O₁₂ (where 0≤x≤1 and 0≤y≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, and/or Li₃₊ₓLa₃M₂O₁₂ (where M may be Te, Nb, or Zr, and x may be an integer from 1 to 10). The solid electrolyte may be applied or prepared by a sintering method and/or the like. For example, the oxide-based solid electrolyte may include a garnet-type or kind solid electrolyte selected from Li₇La₃Zr₂O₁₂ (LLZO) and Li₃₊ₓLa₃Zr₂₋ₐMₐO₁₂ (M-doped LLZO)(where M may be Ga, W, Nb, Ta, or Al, and x may be an integer from 1 to 10).

The sulfide-based solid electrolyte may include, for example, lithium sulfide, silicon sulfide, phosphorus sulfide, boron sulfide, or a combination thereof. Particles of the sulfide-based solid electrolyte may include Li₂S, P₂S₅, SiS₂, GeS₂, B₂S₃, or a combination thereof. The particles of the sulfide-based solid electrolyte particles may include Li₂S or P₂S₅. The particles of the sulfide-based solid electrolyte particles are suitable to have higher lithium ionic conductivity than other inorganic compounds. For example, the sulfide-based solid electrolyte may include Li₂S and P₂S₅. If (e.g., when) the sulfide solid electrolyte material constituting the sulfide-based solid electrolyte includes Li₂S—P₂S₅, a mixing molar ratio of Li₂S to P₂S₅ may be, for example, in a range of about 50:50 to about 90:10. In some embodiments, an inorganic solid electrolyte applied or prepared by adding Li₃PO₄, a halogen, a halogen compound, Li₂₊₂ₓZn_{1??x}GeO₄ (“LISICON”, where 0≤x<1), Li_{3+y}PO₄₋ₓNₓ (“LIPON”) (where 0<x<4 and 0<y<3), Li_{3.25}Ge_{0.25}P_{0.75}S₄ (“ThioLISICON”), Li₂O—Al₂O₃—TiO₂—P₂O₅ (“LATP”), and/or the like to an inorganic solid electrolyte, such as Li₂S—P₂S₅, SiS₂, GeS₂, B₂S₃, or a combination thereof, may be utilized as the sulfide solid electrolyte. Non-limiting examples of the sulfide solid electrolyte material are: Li₂S—P₂S₅; Li₂S—P₂S₅—LiX (where X may be a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where 0<m<10, 0<n<10, and Z may be Ge, Zn, or Ga); Li₂S—GeS₂; Li₂S—SiS₂—Li₃PO₄; and Li₂S—SiS₂—LiₚMO_{q} (where 0<p<10, 0<q<10, and M may be P, Si, Ge, B, Al, Ga, or In). In this regard, the sulfide-based solid electrolyte material may be applied or prepared by treating raw starting materials of the sulfide-based solid electrolyte material (e.g., Li₂S, P₂S₅, and/or the like) by a melt quenching method, a mechanical milling method, and/or the like. In some embodiments, a calcination process may be performed after the treatment. The sulfide-based solid electrolyte may be amorphous or crystalline, or may be in a mixed state.

### Lithium Metal Battery

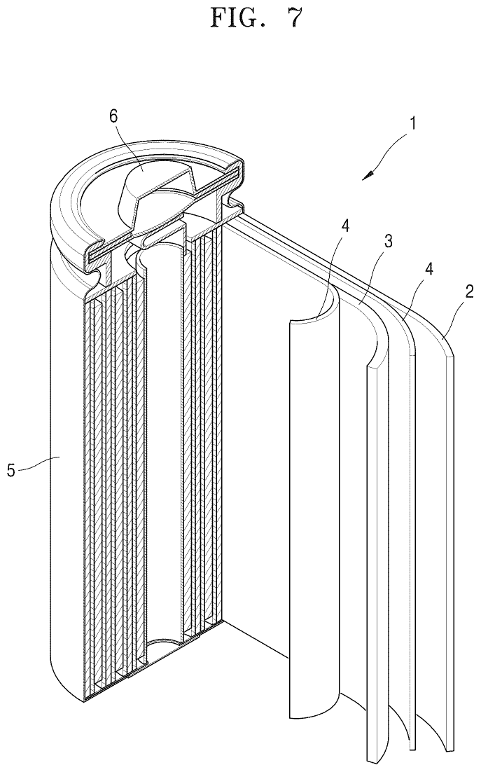

Referring to FIG. 7, the lithium metal battery 1 according to embodiments may include a cathode 3, an anode 2, and an electrolyte 4, wherein the anode is the same as the aforementioned anode. A gel-type or kind polymer electrolyte may be provided between the electrolyte 4 and the cathode 3. The cathode 3, the anode 2, and the electrolyte 4 may be wound or folded to form a battery structure. The formed battery structure may be accommodated in a battery case 5. Then, the battery case 5 may be filled with an organic electrolyte solution, and then sealed with a cap assembly, thereby completing the manufacture of the lithium metal battery 1. The battery case 5 may be a cylindrical-type or kind, but the shape of the battery case 5 is not limited thereto. For example, the battery case 5 may be a square-type or kind, a thin-film type or kind, and/or the like.

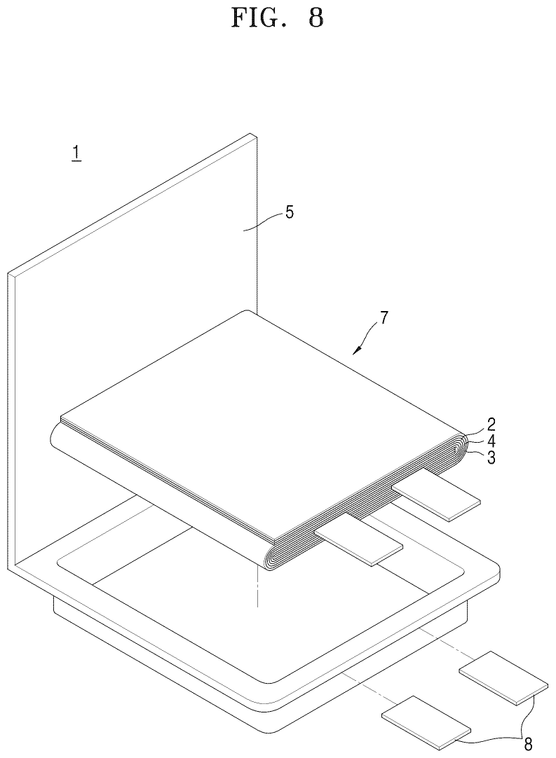

Referring to FIG. 8, the lithium metal battery 1 according to embodiments may include the cathode 3, the anode 2, and the separator 4. The electrolyte 4 may be provided between the cathode 3 and the anode 2, and the cathode 3, the anode 2, and the electrolyte 4 may be wound or folded to form the battery structure 7. The formed battery structure may be accommodated in a battery case 5. The lithium metal battery 1 may include electrode tabs 8 serving as an electrical path for inducing a current formed in the battery structure 7 to the outside. Then, the battery case 5 may be filled with an organic electrolyte solution, and then sealed, thereby completing the manufacture of the lithium metal battery 1. The battery case 5 may be a square-type or kind, but the shape of the battery case 5 is not limited thereto. For example, the battery case 5 may be a cylindrical-type or kind, a thin-film type or kind, and/or the like.

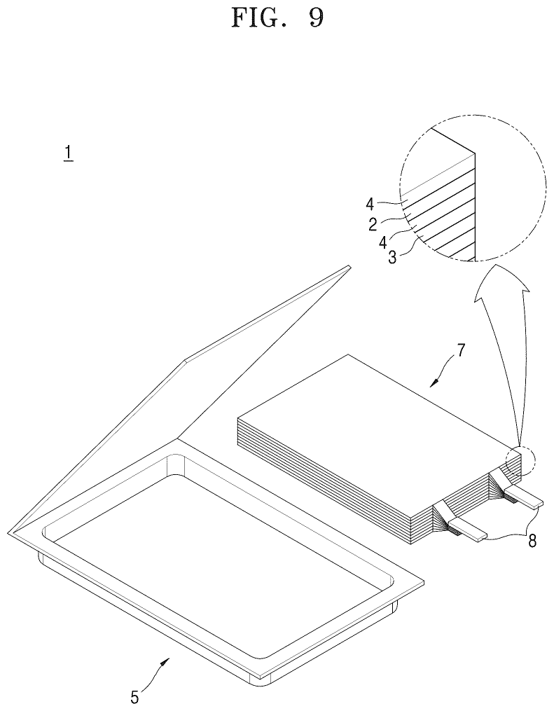

Referring to FIG. 9, the lithium metal battery 1 according to embodiments may include the cathode 3, the anode 2, and the electrolyte 4. The electrolyte 4 may be provided between the cathode 3 and the anode 2 to form the battery structure 7. A gel-type or kind polymer electrolyte between a separator and the cathode may not be illustrated in the drawing. The battery structure 7 may be laminated in a bi-cell structure, and then accommodated in the battery case 5. The lithium metal battery 1 may include the electrode tab 8 serving as an electrical path for inducing a current formed in the battery structure 7 to the outside. Then, the battery case 5 may be filled with an organic electrolyte solution, and then sealed, thereby completing the manufacture of the lithium metal battery 1. The battery case 5 may be a square-type or kind, but the shape of the battery case 5 is not limited thereto. For example, the battery case 5 may be a cylindrical-type or kind, a thin-film type or kind, and/or the like.

A pouch-type or kind lithium metal battery corresponds to utilization of a pouch as a battery case for each of the lithium batteries of FIGS. 8 and 9. A pouch-type or kind lithium metal battery may include one or more battery structures. The electrolyte 4 may be provided between the cathode 3 and the anode 2, or the electrolyte 4 and a separator may be provided between the cathode 3 and the anode 2, so as to form the battery structure 7. The battery structure 7 may be laminated as a bi-cell structure, impregnated with liquid electrolyte, and then accommodated and sealed in a pouch, thereby completing the manufacture of a pouch-type or kind lithium metal battery. For example, although not illustrated in the drawings, the cathode 3, anode 2, and the separator may be simply laminated in the form of an electrode assembly and then accommodated in a pouch, or may be wound or folded into a jelly roll-type or kind electrode assembly and then accommodated in a pouch. Then, after injecting an organic electrolyte solution into the pouch, and the pouch may be sealed, thereby completing the manufacture of the lithium metal battery.

The lithium metal battery of the present disclosure may have excellent or suitable discharge capacity and lifespan characteristics, and may also have high energy density, and thus may be, for example, utilized in an electric vehicle (EV). For example, the lithium metal battery may be utilized in a hybrid vehicle, such as a plug-in hybrid electric vehicle (PHEV) and/or the like. The lithium metal battery may also be applicable to the fields requiring high-power storage. For example, the lithium metal battery may be utilized in an electric bicycle, a power tool, and/or the like.

Multiple units of the lithium metal battery may be laminated to form a battery module, and multiple units of such a battery module may form a battery pack. The battery pack may be utilized in a device that requires high capacity and large output. For example, the battery pack may be utilized in a laptop computer, a smart phone, an electronic vehicle, and/or the like. The battery module may include, for example, multiple batteries and a frame that holds the multiple batteries. The battery pack may include, for example, multiple battery modules and a bus bar that connects the battery modules together. The battery module and/or the battery pact may further include a cooling device. The multiple battery packs may be managed by a battery management system. The battery management system may include a battery pack and an electronic control device connected to the battery pack.

### Method of Applying or Preparing Lithium Metal Battery

A method of applying or preparing a lithium metal battery according to embodiments may include: applying or preparing an anode current collector; forming a protective layer by applying and drying a composition for forming a protective layer onto the anode current collector; applying or preparing an electrolyte; applying or preparing a cathode; and applying or preparing an assembly by stacking the anode current collector with the protective layer, the electrolyte, and the cathode.

The composition for forming the protective layer may include the first polymer including a hydroxyl group, and also i) boric acid (H₃BO₃), ii) a hydrate of boron oxide (B₂O₃) and water, or iii) a combination thereof. The composition for forming the protective layer may further include the second polymer having a functional group crosslinkable with the first polymer including a hydroxyl group. The protective layer formed by utilizing the composition for forming a protective layer may further include a cross-linked polymer of the first polymer and the second polymer. The mixing ratio of the first polymer including a hydroxyl group to the second polymer may be adjusted to be in a range of about 50:50 to about 99:1, or about 60:40 to about 90:10.

The second polymer may include at least one of a fluorinated polyamic acid and a fluorinated polyimide, each including a carboxyl group.

If (e.g., when) the second polymer is fluorinated polyamic acid including a carboxyl group, the composition for forming a protective layer including the second polymer may be applied to the anode current collector, dried, and then heat-treated to carry out a cross-linking reaction between the first polymer and the second polymer, so as to form the protective layer including a cross-linked polymer. The temperature at which the heat treatment is performed may vary depending on the compositions of the first polymer and the second polymer, but may be, for example, performed at a temperature in a range of about 80° C. to about 200° C., about 100° C. to about 200° C., about 150° C. to about 200° C., or about 150° C. to about 190° C. If (e.g., when) the temperature at which the heat treatment is performed is within the ranges described, the protective layer formed on the electrode surface may minimize or reduce the exposure of an electrolyte solution to the electrode surface and create a substantially uniform flow of lithium ions across the electrode, thereby effectively suppressing the growth of lithium dendrites.

The composition for forming a protective layer may further include a lithium salt.

The lithium metal battery may further include a separator. The separator may further include a liquid electrolyte and/or a gel-type or kind polymer electrolyte.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, the present creative idea will be described in more detail through Examples and Comparative Examples. However, these examples are provided to represent the creative idea, and the scope of the present creative idea is not limited thereto.

### EXAMPLES

### Preparation Example 1: Preparation of Polymer Solution Containing Polyvinyl Alcohol (PVA) and Fluorinated Polyamic Acid of Formula 10

PVA was purchased from Sigma-Aldrich. A synthesis process of fluorinated polyamic acid of Formula 10 is as follows.

First, a round-bottom flask was filled with nitrogen, and 4.9411 g (0.00154 mol) of 2,2′-bis (trifluoromethyl)benzidine (TFDB) and 0.7825 g (0.00051 mol) of diaminobenzic acid (DABA) were added thereto. Then, 131 g of N-methylpyrrolidone (NMP) was added, and the mixed solution was completely dissolved by utilizing a mechanical stirrer. Next, 9.2764 g (0.0209 mol) of 4,4′-(hexafluoroisopropylidene) (6FDA) was added thereto and stirred at room temperature (25° C.) for 24 hours, so as to prepare polyamic acid represented by Formula 9. The polyamic acid thus applied or prepared was a random copolymer. The molar ratio of 6FDA:TFDB:DABA was 4:3:1.

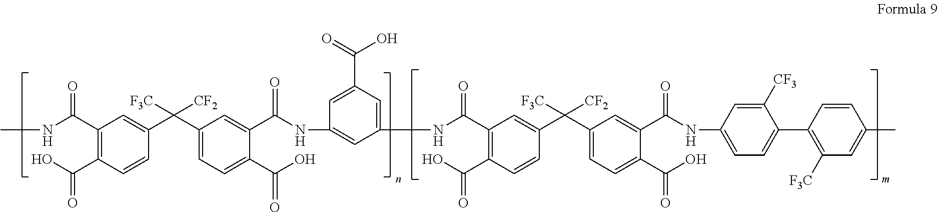

In Formula 9, the molar ratio of n:m was 1:3.

To the polyamic acid of Formula 9 (6FDA:TFDB:DABA, acid equivalent of 210 g/eq), 10 g of LiOH aqueous solution was added with respect to the equivalent ratio of the carboxylic acid, so as to prepare water-soluble polyamic acid represented by Formula 10 in which 0.5 equivalents of COOH in the COOH of the polyamic acid was substituted with COO—Li+. Here, the LiOH aqueous solution had 0.5 equivalents relative to 1 equivalent of carboxylic acid of the polyamic acid.
wherein, n was 0.25, and m was 0.75.

The water-soluble polyamic acid of Formula 10 and the PVA (weight average molecular weight, Mw=89,000, hydrolysis+99%) were mixed in a weight ratio of 20:80, so as to prepare a polymer solution of 10 wt % solids.

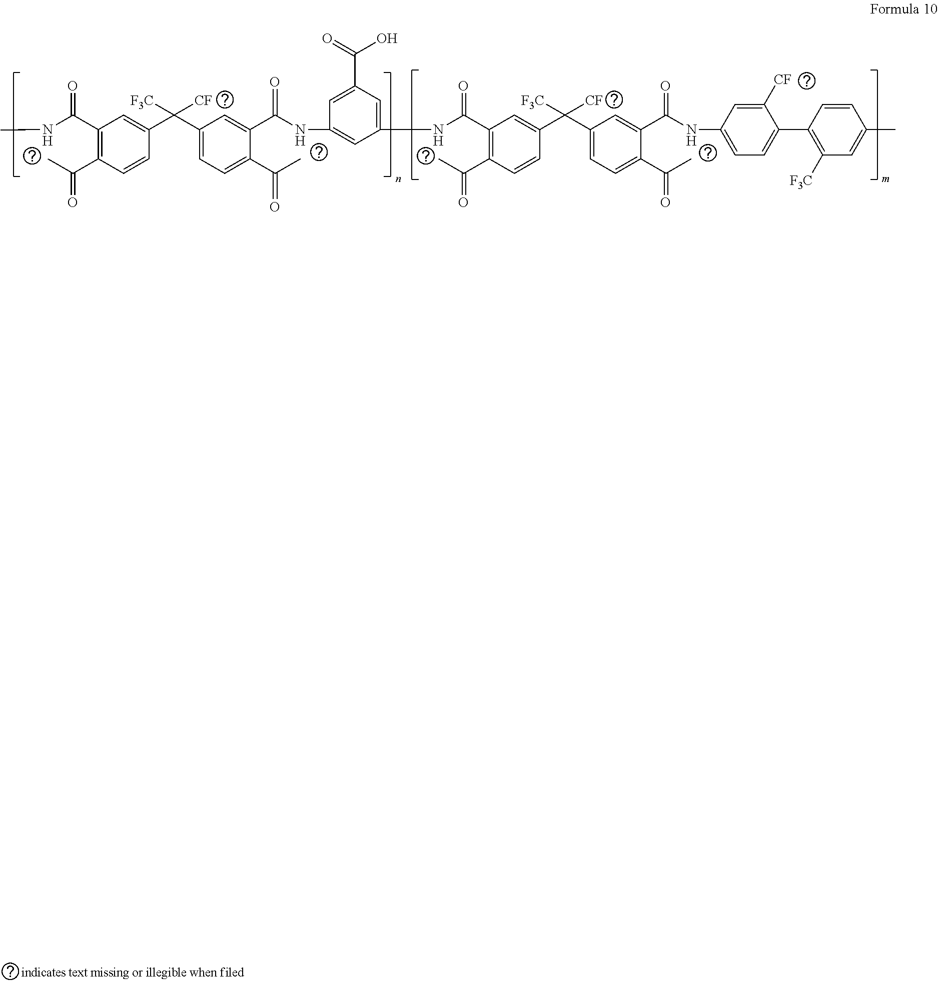

wherein, n was 0.25, and m was 0.75.

### Example 1: Protective Layer: Boric Acid 0.5%+PVA/PI-F

The polymer solution of 10 wt % solids applied or prepared according to Preparation Example 1 by mixing the water-soluble polyamic acid of Formula 10 with PVA in a weight ratio of 20:80, and boric acid (H₃BO₃) were applied or prepared, and then mixed with NMP as a solvent, so as to prepare a composition for forming a protective layer. The amount of the boric acid was 0.5 parts by weight based on 100 parts by weight of the composition for forming a protective layer, and the amount of the solvent was 99.5 parts by weight based on 100 parts by weight of the composition for forming a protective layer.

The composition for forming a protective layer was applied onto a 10 micrometer (μm)-thick-copper foil as an anode current collector, dried in a vacuum oven at 80° C. for 30 minutes, and then heat-treated at 180° C. for 30 minutes, so as to prepare an anode. The anode thus applied or prepared had a structure in which the lithium metal thin film provided on the copper current collector was coated with the protective layer to a thickness of 10 μm.

By the heat treatment, the carboxyl group included in the polyamic acid of Formula 10 reacted with the hydroxyl group of the PVA to form an ester linker, and in this regard, a cross-linked polymer (PVA/PI-F) of polyimide of Formula 12 and the PVA was formed. The cross-linked polymer PVA/PI-F may have a three-dimensional network structure in which the polyimide of Formula 12 and the PVA were cross-linked at multiple points.

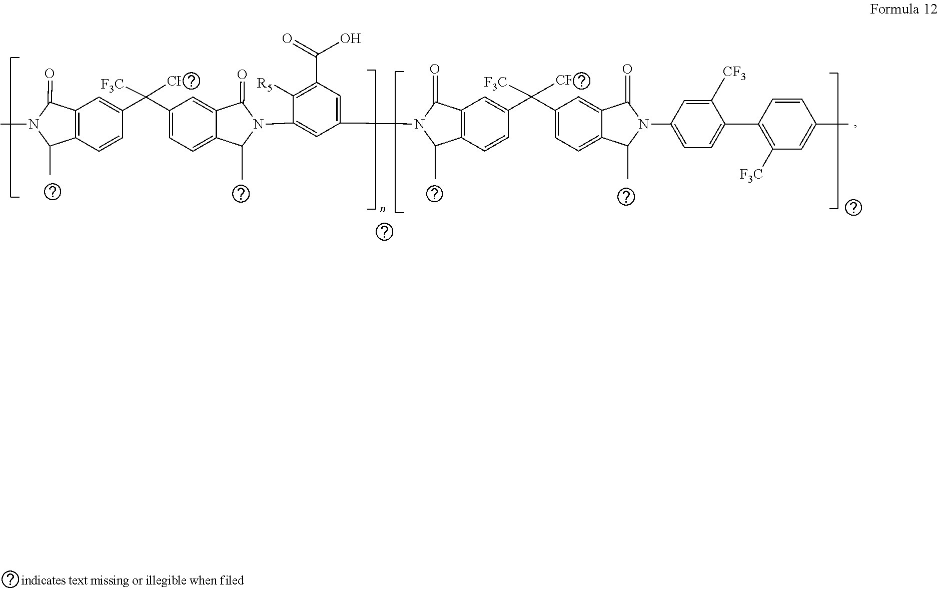

wherein, in the formula herein, n was 0.25, m was 0.75, and the weight average molecular weight of the polyimide of Formula 12 was about 2,000,000.

A 20 μm-thick polyethylene single layer as a separator was laminated on the anode, and a cathode was laminated on the other side of the separator, so as to prepare a laminate. A liquid electrolyte was injected into the laminate thus applied or prepared, so as to prepare a lithium metal battery.

The lithium metal battery had a cathode/gel-type or kind polymer electrolyte(separator)/protective layer/anode current collector structure. For utilization as the liquid electrolyte, a solution in which 0.6 M of LiBF₄ and 0.6 M of lithium difluoro(oxalate)borate (LiDFOB) were added to a mixed solvent of diethyl carbonate (DEC) and fluoroethylene carbonate (FEC) mixed at a volume ratio of 2:1.

The cathode was applied or prepared as follows.

Li_{1.04}Ni_{0.88}Co_{0.1}Al_{0.02}O₂ powder and a carbon-based conductive material (Super-P; Timcal Ltd.) were mixed uniformly in a weight ratio of 90:5, and a polyvinylidene fluoride (PVDF) binder solution was added thereto, so as to prepare a cathode active material slurry in which the weight ratio of the active material:carbon-based conductive material:binder was 90:5:5.

The slurry thus applied or prepared was applied onto a 15 μm-thick-aluminum substrate by utilizing a doctor blade, dried at 120° C. under reduced pressure, and then rolled into a sheet form by utilizing a roll press, so as to prepare a cathode.

### Example 2: Protective Layer: Boric Acid 1%+PVA/PI-F

A protective layer and a lithium metal battery including the same were applied or prepared in substantially the same manner as in Example 1, except that the amount of boric acid was changed to 1 wt % based on 100 parts by weight of the composition for forming a protective layer.

### Example 3: Protective Layer: Boric Acid 2%+PVA/PI-F

A protective layer and a lithium metal battery including the same were applied or prepared in substantially the same manner as in Example 1, except that the amount of boric acid was changed to 2 wt % based on 100 parts by weight of the composition for forming a protective layer.

### Example 4: Protective Layer: Boric Acid 5%+PVA/PI-F

A protective layer and a lithium metal battery including the same were applied or prepared in substantially the same manner as in Example 1, except that the amount of boric acid was changed to 5 wt % based on 100 parts by weight of the composition for forming a protective layer.

### Example 5: Protective layer: Boric acid 0.5%+CMC

A protective layer and a lithium metal battery including the same were applied or prepared in substantially the same manner as in Example 1, except that carboxymethyl cellulose (CMC) was utilized instead of the polymer solution of Preparation Example 1.

### Example 6

A protective layer and a lithium metal battery including the same were applied or prepared in substantially the same manner as in Example 1, except that hydroxyethyl methacrylate was utilized instead of the water-soluble polyamic acid of Formula 10 in forming the polymer solution with solids content (e.g., amount) of 10 wt %.

### Example 7

A protective layer and a lithium metal battery including the same were applied or prepared in substantially the same manner as in Example 1, except that hydroxypropyl acrylate was utilized instead of the water-soluble polyamic acid of Formula 10 in forming the polymer solution with solids content (e.g., amount) of 10 wt %.

### Comparative Example 1

A protective layer and a lithium metal battery including the same were applied or prepared in substantially the same manner as in Example 1, except that boric acid (H₃BO₃) was not added in applying or preparing the composition for forming a protective layer.

### Comparative Example 2

A composition for forming a protective layer was applied or prepared by adding polyethylene oxide (MV: 4,000,000) and lithium bis(trifluoromethane sulfonyl)imide (LiTFSI, ((CF₃SO₂)₂NLi) to an acetonitrile solvent and mixed to have a ratio of EO:Li-9:1 (repeating unit of EO:PEO).

A protective layer and a lithium metal battery including the same were applied or prepared in substantially the same manner as in Example 1, except that the composition for forming a protective layer of Composition Example 2 was utilized instead of the composition for forming a protective layer of Example 1.

### Evaluation Example 1: Lifespan at Room Temperature (25° C.)

The charge/discharge characteristics for the lithium metal batteries of Examples 1 to 7 and Comparative Examples 1 and 2 were evaluated under the following conditions.

Each lithium metal battery was charged with a constant current of 0.1 C rate at 25° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.1 C rate until the voltage reached 3.6 V (vs. Li) during discharging (formation cycle).

Each lithium metal battery having undergone the formation cycle was charged with a constant current of 0.2 C rate at 25° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.5 C rate until the voltage reached 3.6 V (vs. Li) during discharging (1st cycle). This cycle was repeated until the 100^{th} cycle under the same conditions.

In all charging and discharging cycles, a 10-minute stop time was provided after every (one) charging and discharging cycle. Some of the results of the charge/discharge test at room temperature are shown in Table 1. Capacity retention ratio was defined by Equation 1.

$$Capacity retention ( \% ) = ( discharge capacity in {100}^{th} cycle / discharge capacity in {1}^{st} cycle ) \times 100 \qquad Equation 1$$

TABLE 1

| Class | Capacity retention rate (%) |
|---|---|
| Example 1 | 68.4 |
| Example 2 | 73.1 |
| Example 3 | 67.9 |
| Example 4 | 64.3 |
| Example 5 | 61.1 |
| Comparative | 55.7 |
| Example 1 | |
| Comparative | 43.2 |
| Example 2 | |

As shown in Table 1, the lithium metal battery of Comparative Example 1 had a decreased capacity retention rate due to a side reaction between lithium and an electrolyte caused by the growth of dendrites due to the absence of a protective layer, and the lithium metal battery of Comparative Example 2 had a structure in which a polyethylene oxide protective layer was formed on the anode current collector, but the protective layer was not effective enough to suppress or reduce the growth of dendrites. Thus, compared to the lithium metal batteries of Examples 1 to 5, if (e.g., when) the protective layer was formed on the anode current collector, the physical properties of the protective layer increased without a decrease in the ion conductivity, resulting in a degradation in the capacity reaction characteristics of the lithium metal battery.

The capacity retention rates of the lithium metal batteries of Examples 6 and 7 were similar to the capacity retention rate of the lithium metal battery of Example 1.

### Evaluation Example 2: Lifespan at High Temperature (45° C.)

The charge/discharge characteristics for the lithium metal batteries of Examples 1 to 5 and Comparative Examples 1 and 2 were evaluated under the following conditions.

Each lithium metal battery was charged with a constant current of 0.1 C rate at 45° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.1 C rate until the voltage reached 3.6 V (vs. Li) during discharging (formation cycle).

Each lithium metal battery having undergone the formation cycle was charged with a constant current of 0.2 C rate at 25° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.5 C rate until the voltage reached 3.6 V (vs. Li) during discharging (1st cycle). This cycle was repeated until the 100^{th} cycle under the same conditions.

In all charging and discharging cycles, a 10-minute stop time was provided after every (one) charging and discharging cycle. Some of the results of the charging and discharging test at room temperature are shown in Table 2. Capacity retention ratio was defined by Equation 2.

$$Capacity retention ( \% ) = ( discharge capacity in {100}^{th} cycle / discharge capacity in {1}^{st} cycle ) \times 100 \qquad Equation 2$$

TABLE 2

| Class | Capacity retention rate (%) |
|---|---|
| Example 1 | 84.5 |
| Example 2 | 85.1 |
| Example 3 | 83.7 |
| Example 4 | 80.9 |
| Example 5 | 75.7 |
| Comparative | 74.1 |
| Example 1 | |
| Comparative | 65.3 |
| Example 2 | |

As shown in Table 2, the lithium metal battery of Comparative Example 1 had a decreased capacity retention rate at high temperature due to a side reaction between lithium and an electrolyte caused by the growth of dendrites due to the absence of a protective layer, and the lithium metal battery of Comparative Example 2 had a structure in which a polyethylene oxide protective layer was formed on the anode current collector, but the protective layer was not effective enough to suppress or reduce the growth of dendrites, resulting in degraded characteristics of capacity reaction rate at high temperature compared to the lithium metal batteries of Examples 1 to 5.

### Evaluation Example 3: High-Rate Characteristics

Each of the lithium metal batteries applied or prepared in Examples 1 to 5 and Comparative Examples 1 and 2 was charged with a constant current of 0.1 C rate at 25° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.1 C rate until the voltage reached 3.6 V (vs. Li) during discharging (formation cycle).

Each lithium metal battery having undergone the formation cycle was charged with a constant current of 0.2 C rate at 25° C. until a voltage reached 4.3 V (vs. Li), and was then cut-off at a current of 0.05 C rate while maintaining the voltage at 4.3 V in a constant voltage mode. Subsequently, each lithium metal battery was discharged with a constant current of 0.5 C rate until the voltage reached 3.6 V (vs. Li) during discharging (1st cycle).

The lithium metal batteries that have undergone the 1^{st} cycle were charged with in a constant current mode at a current rate of 0.2 C at 25° C. until the voltage reached 4.3 V (vs. Li), and then, while maintaining the voltage of 4.3 V in the constant voltage mode, the voltage was cut-off at a current rate of 0.05 C. Subsequently, the batteries were discharged at a constant current rate of 0.2 C until the voltage reached 2.8 V (vs. Li) (2^{nd} cycle).

The 2^{nd} cycle was repeated until the 7^{th} cycle under the same conditions.

The lithium metal batteries that have undergone the 7^{th} cycle were charged with in a constant current mode at a current rate of 0.33 C at 25° C. until the voltage reached 4.35 V (vs. Li), and then, while maintaining the voltage of 4.35 V in the constant voltage mode, the voltage was cut-off at a current rate of 0.05 C. Subsequently, the batteries were discharged at a constant current rate of 0.5 C until the voltage reached 2.8 V (vs. Li) (8^{th} cycle).

The 8^{th} cycle was repeated until the 17^{th} cycle under the same conditions.

The lithium metal batteries that have undergone the 17^{th} cycle were charged with in a constant current mode at a current rate of 0.33 C at 25° C. until the voltage reached 4.35 V (vs. Li), and then, while maintaining the voltage of 4.35 V in the constant voltage mode, the voltage was cut-off at a current rate of 0.05 C. Subsequently, the batteries were discharged at a constant current rate of 1 C until the voltage reached 2.8 V (vs. Li) (18^{th} cycle).

The 18^{th} cycle was repeated until the 25^{th} cycle under the same conditions.

The lithium metal batteries that have undergone the 25^{th} cycle were charged with in a constant current mode at a current rate of 0.33 C at 25° C. until the voltage reached 4.35 V (vs. Li), and then, while maintaining the voltage of 4.35 V in the constant voltage mode, the voltage was cut-off at a current rate of 0.05 C. Subsequently, the batteries were discharged at a constant current rate of 2 C until the voltage reached 2.8 V (vs. Li) (26^{th} cycle).

The 26^{th} cycle was repeated until the 35^{th} cycle under the same conditions.

The lithium metal batteries that have undergone the 35^{th} cycle were charged with in a constant current mode at a current rate of 0.33 C at 25° C. until the voltage reached 4.35 V (vs. Li), and then, while maintaining the voltage of 4.35 V in the constant voltage mode, the voltage was cut-off at a current rate of 0.05 C. Subsequently, the batteries were discharged at a constant current rate of 3 C until the voltage reached 2.8 V (vs. Li) (36^{th} cycle).

The lithium metal batteries that have undergone the 36^{th} cycle were charged with in a constant current mode at a current rate of 0.33 C at 25° C. until the voltage reached 4.35 V (vs. Li), and then, while maintaining the voltage of 4.35 V in the constant voltage mode, the voltage was cut-off at a current rate of 0.05 C. Subsequently, each of the lithium batteries was discharged at a constant current of 0.2 C rate until the voltage reached 2.8 V (vs. Li) (45th cycle), and such a cycle was repeated under the same conditions until the 100th cycle.

After every (one) charge/discharge cycle in all the charge/discharge cycles, there was a 10-minute pause time.

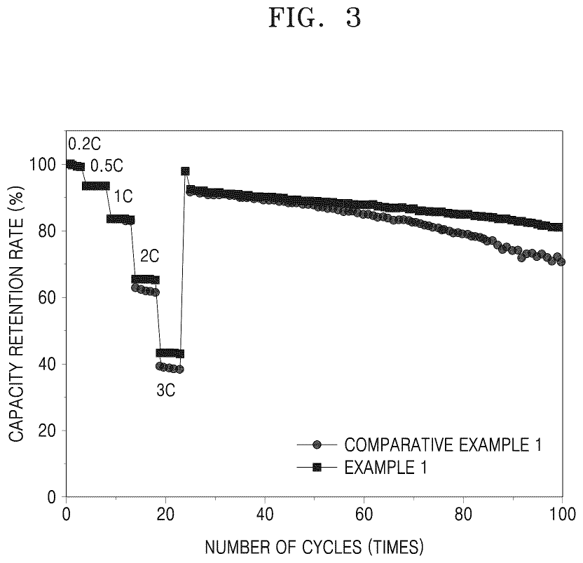

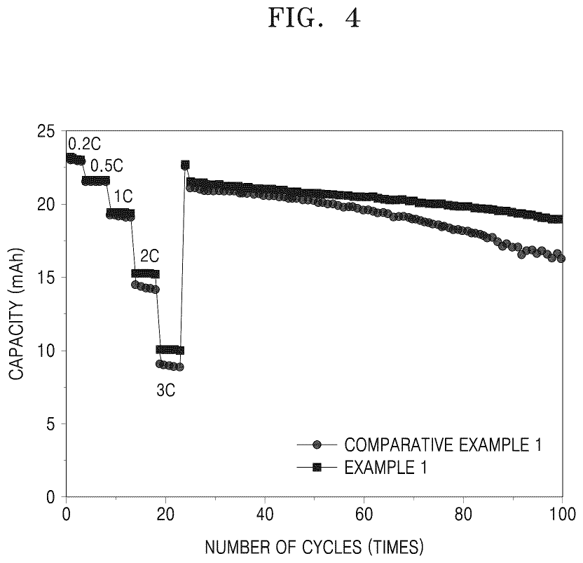

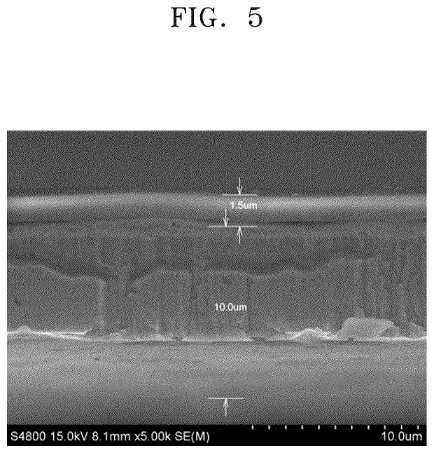

Some of the results of the charge/discharge test are shown in Table 3. FIGS. 3 and 4 show changes in the capacity retention rates and changes in the capacity characteristics, respectively, according to the number of cycles of the lithium metal batteries of Example 1 and Comparative Example 1.

The high-rate characteristics were defined by Equation 3:

$$High - rate characteristics [ \% ] = [ discharge capacity at {25}^{th} cycle ( 1 C rate ) / discharge capacity at {2}^{nd} cycle ( 0.2 C rate ) ] \times 100 \qquad Equation 3$$

TABLE 3

| | Composition of protective | High-rate |
|---|---|---|
| Class | layer | characteristics (%) |
| Example 1 | Boric acid 0.5% + PVA/PI-F | 84.3 |
| Example 2 | Boric acid 1% + PVA/PI-F | 84.1 |
| Example 3 | Boric acid 2% + PVA/PI-F | 83.3 |
| Example 4 | Boric acid 5% + PVA/PI-F | 81.0 |
| Example 5 | Boric acid 0.5% + CMC | 73.5 |
| Comparative | PVA/PI-F | 72.1 |
| Example 1 | | |
| Comparative | PEO/LITFSi (9:1) | 65.3 |
| Example 2 | | |

Referring to Table 3, in the lithium metal batteries of Examples 1 to 4, the protective layer on the anode current collector included boric acid so that the transfer of lithium ions was improved and the ion conductivity characteristics were improved accordingly. In this regard, the high-rate characteristics of the lithium metal batteries of Examples 1 to 4 were significantly improved compared to the lithium metal battery of Comparative Example 1 not including the protective layer.

The lithium metal battery of Comparative Example 2 included the polyethylene oxide protective layer, and thus had decreased high-rate characteristics compared to the lithium metal battery of Comparative Example 1. However, compared to the lithium metal batteries of Examples 1 to 4 including the PVA/PI-F and the boric acid and the lithium metal battery of Example 5 including the CMC and the boric acid, the lithium metal battery of Comparative Example 2 showed (even more) poor results in the high-rate characteristics. From this, it was confirmed that the physical strength of the protective layer in each of the lithium metal batteries of Examples 1 to 5 increased, thereby further increasing the stability and improving the high-rate characteristics upon the improved ion conductivity.

### Evaluation Example 4: SEM Analysis I

For the lithium metal battery of Example 1, the laminate structure of the anode current collector/protective layer was examined by utilizing field emission-scanning electron microscope (FE-SEM), and the results are shown in FIG. 5.

Referring to FIG. 5, it was confirmed that the protective layer was formed to a thickness of about 1.5 μm.

### Evaluation Example 5: SEM Analysis II

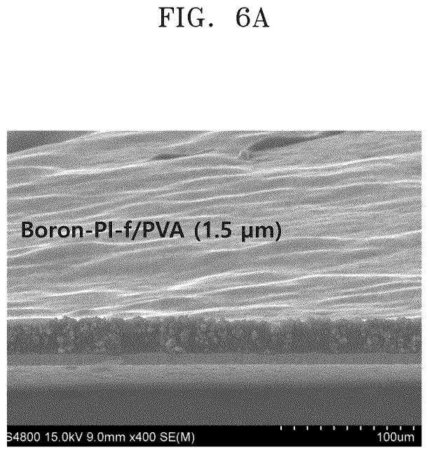

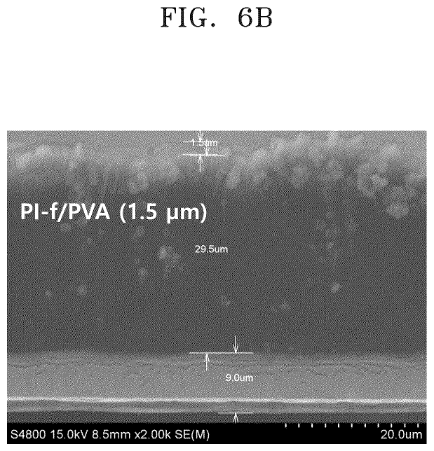

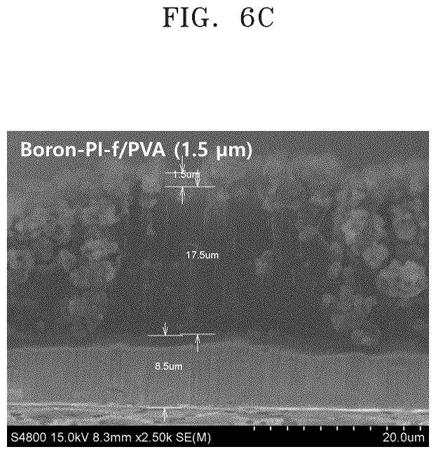

After the lithium metal battery of Example 1 was charged to state of charge (SOC) 100% at 25° C., the lithium metal battery was disassembled, and the cross-section and thickness of lithium bottom electrodeposition and substantially uniform protective layer were measured by utilizing SEM. The analysis results are shown in FIGS. 6A to 6C.

FIG. 6A is an SEM image showing a state of a protective layer laminated on the anode current collector in the lithium metal battery of Example 1. FIGS. 6B and 6C are SEM images showing a structure in which a lithium metal layer was plated on the anode current collector and the protective layer was formed on the plated lithium metal layer.

Referring to FIG. 6A, it was confirmed that the protective layer was formed on the anode current collector. Referring to FIG. 6B and FIG. 6C, it was also confirmed that the thickness of the plated lithium metal layer was relatively small if (e.g., when) boric acid was added, and that the resulting plated lithium metal layer was densely formed.

### Evaluation Example 6: Ion Conductivity

For the lithium metal batteries of Examples 1 to 5, the ion conductivity was examined, and the results are shown in Table 4.

TABLE 4

| | Composition of protective | Ion conductivity |
|---|---|---|
| Class | layer | (mS/cm) |
| Example 1 | Boric acid 0.5% + PVA/PI-F | 0.53 |
| Example 2 | Boric acid 1% + PVA/PI-F | 0.57 |
| Example 3 | Boric acid 2% + PVA/PI-F | 0.71 |
| Example 4 | Boric acid 5% + PVA/PI-F | 0.68 |
| Example 5 | Boric acid 0.5% + CMC | 0.40 |

As shown in Table 4, it was confirmed that the lithium metal batteries of Examples 1 to 5 had excellent or suitable ion conductivity.

Although example embodiments have been described in more detail with reference to the accompanying drawings, the present disclosure is not limited to these examples. It is obvious that those skilled in the art to which the present creative idea belongs can derive one or more suitable examples of changes or modifications within the scope of the technical idea described in the claims, and these, of course, belong to the technical scope of the present creative idea.

According to the one or more embodiments, by including an anode for a lithium metal battery having a new structure, deterioration of an anode active material layer may be prevented or reduced, and accordingly a lithium metal battery having improved high-rate characteristics and lifespan characteristics may be provided.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the present disclosure as defined by the following claims and equivalents thereof.

What is claimed is:

1. An anode comprising:
an anode current collector; and
a protective layer on the anode current collector,
wherein the anode is for a lithium metal battery,
wherein:
the anode further comprises an anode active material layer between the anode current collector and the protective layer; or
the anode is free of an anode active material layer, and
wherein the protective layer comprises:
a first polymer comprising a hydroxyl group, and
i) boric acid (H₃BO₃), ii) a hydrate of boron oxide (B₂O₃) and water, or iii) a combination thereof.

2. The anode as claimed in claim 1, wherein the first polymer comprises:
a polymerization product of at least one monomer selected from among: carboxymethyl cellulose (CMC), polyvinyl alcohol (PVA), vinylacetate, butyl (meta)acrylate, 2-hydroxyethyl (meta)acrylate, 2-hydroxypropyl (meta)acrylate, 4-hydroxybutyl (meta)acrylate, 6-hydroxyhexyl (meta) acrylate, 8-hydroxyoctyl (meta)acrylate, 2-hydroxyethyleneglycol (meta)acrylate, 2-hydroxypropyleneglycol (meta)acrylate, acrylic acid, methacrylic acid, 2-(meta)acryloyloxy acetic acid, 3-(meta)acryloyloxy propyl acid, 4-(meta)acryloyloxy butyl acid, itaconic acid, maleic acid, 2-isocyanatoethyl (meta)acrylate, 3-isocyanatopropyl (meta)acrylate, 4-isocyanatobutyl (meta)acrylate, (meta)acrylamide, ethylene di(meta)acrylate, diethylene glycol(meta)acrylate, triethyleneglycol di(meta)acrylate, trimethylenepropane tri(meta)acrylate, trimethylenepropanetriacrylate, 1,3-butandiol (meta)acrylate, 1,6-hexanediol di(meta)acrylate, allyl acrylate, and N-vinylcaprolactam;
a hydrolysate of the polymerization product; or
a combination thereof.

3. The anode as claimed in claim 1, wherein the protective layer further comprises:
a second polymer having a functional group crosslinkable with the first polymer comprising a hydroxyl group, and
a cross-linked polymer of the first polymer and the second polymer.

4. The anode as claimed in claim 3, wherein the second polymer comprises at least one of a fluorinated polyamic acid comprising a carboxyl group or a fluorinated polyimide comprising a carboxyl group.

5. The anode as claimed in claim 1, wherein an amount of i) the boric acid (H₃BO₃), ii) the hydrate of boron oxide (B₂O₃) and water, or iii) the combination thereof in the protective layer is at most 5 wt % based on 100 wt % of a total weight of the protective layer.

6. The anode as claimed in claim 4, wherein the fluorinated polyamic acid is a polymer represented by Formula 1 or Formula 2, and
the fluorinated polyimide is a polymer represented by Formula 3 or Formula 4: 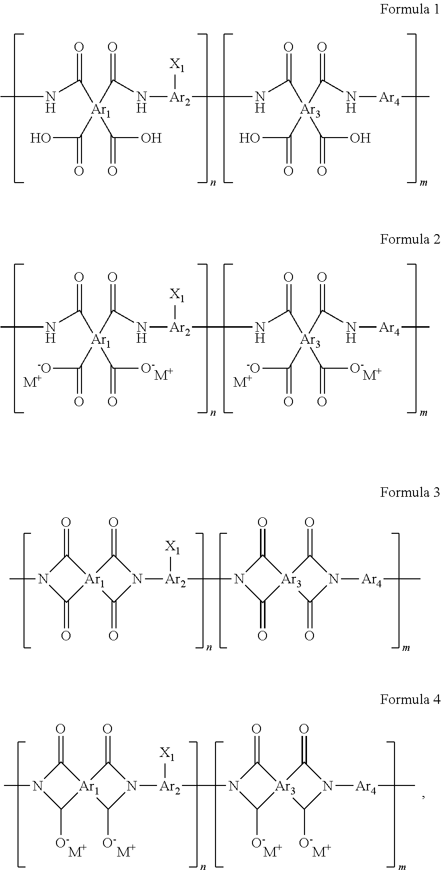
wherein, M is alkali metal,
wherein Ar₁ and Ar₃ are each independently an aromatic cyclic group selected from among substituted or unsubstituted tetravalent C6-C24 arylene groups and substituted or unsubstituted tetravalent C4-C24 heteroarylene groups, the aromatic cyclic group comprising one aromatic ring, a fused ring of at least two aromatic rings, or at least two aromatic rings linked together via a single bond, —O—, —S—, —C(═O)—, —S(═O)₂—, —Si(Ra)(Rb)— (wherein Ra and Rb are each independently a C1-C10 alkyl group), a substituted or unsubstituted C1-C10 alkylene group, or —C(═O)—NH—,
wherein Ar₂ and Ar₄ are each independently an aromatic cyclic group selected from among substituted or unsubstituted divalent C6-C24 arylene groups and substituted or unsubstituted divalent C4-C24 heteroarylene groups, the aromatic cyclic group comprising one aromatic ring, a fused ring of at least two aromatic rings, or at least two aromatic rings linked together via a single bond, —O—, —S—, —C(═O)—, —S(═O)₂—, —Si(Ra)(Rb)— (wherein Ra and Rb are each independently a C1-C10 alkyl group), a substituted or unsubstituted C1-C10 alkylene group, or —C(═O)—NH—, and
wherein at least one of Ar₁ to Ar₄ is substituted with a halogen group,
X₁ comprises, as a first functional group, —COOH, —OH, —CO—NH₂, or —COH, and
n and m each indicate a mole fraction within a repeating unit and satisfy 0<n≤1, 0≤m<1, and n+m=1.

7. The anode as claimed in claim 6, wherein the fluorinated polyamic acid is a polymer represented by Formula 5 or Formula 6, and
the fluorinated polyimide is a polymer represented by Formula 7 or Formula 8: 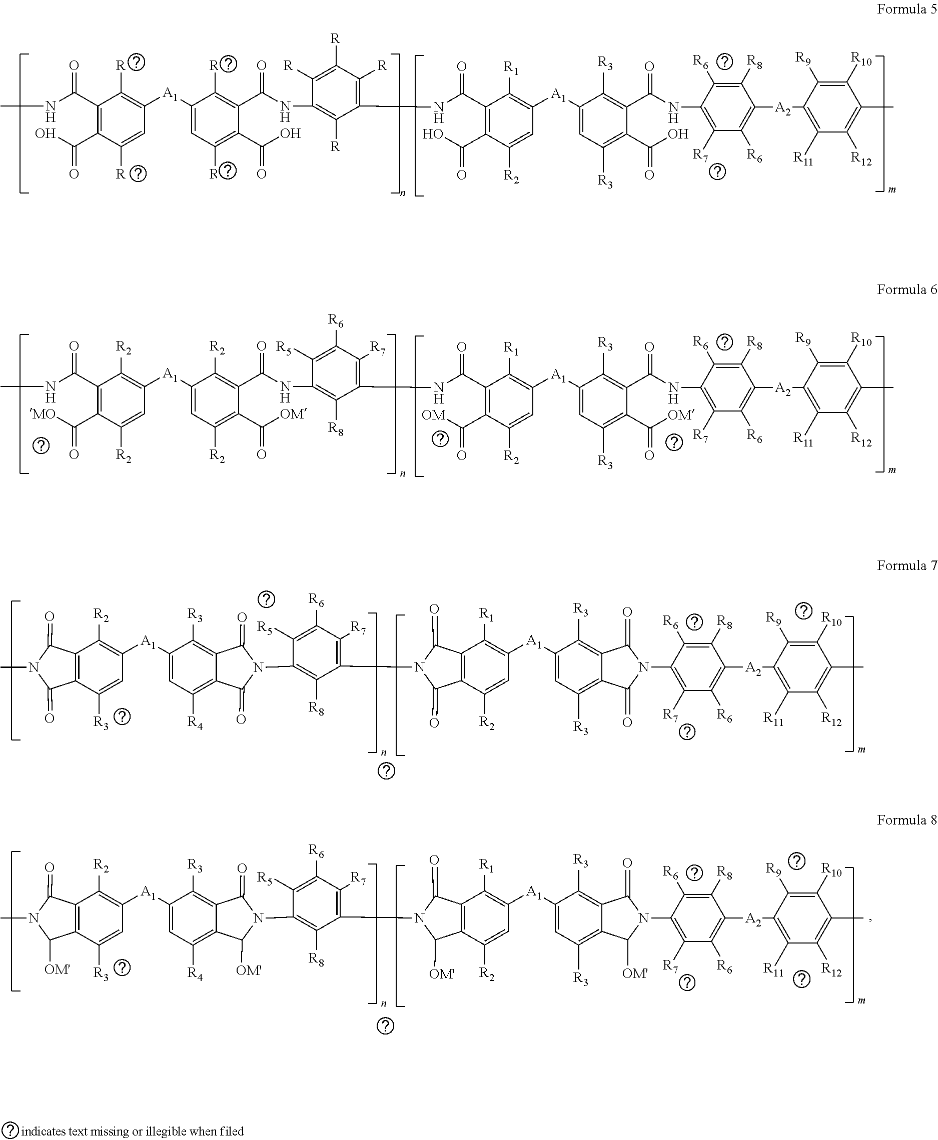
wherein, M is lithium or sodium,
R₁, R₂, R₃, R₄, R₅, R₆, R₇, R₈, R₉, R₁₀, R₁₁, and R₁₂ are each independently hydrogen, halogen, —COOH, —OH, —CO—NH₂, —COH, a C1-C10 alkyl group unsubstituted or substituted with a halogen, a C6-C20 aryl group unsubstituted or substituted with a halogen, or a C2-C20 heteroaryl group unsubstituted or substituted with a halogen,
at least one of R₁ to R₁₂ is a halogen group or the C1-C10 alkyl group substituted with a halogen group,
A₁ and A₂ are each independently a single bond, —O—, —S—, —C(═O)—, —S(═O)₂—, —Si(Ra)(Rb)— (wherein Ra and Rb are each independently a C1-C10 alkyl group), a C1-C10 alkylene group unsubstituted or substituted with a halogen, or —C(═O)—NH—,
at least one of R₅, R₆, R₇, or R& is-COOH, —OH, —CO—NH₂, or —COH, and
n and m each indicate a mole fraction within a repeating unit and satisfy 0<n≤1, 0≤m<1, and n+m=1.

8. The anode as claimed in claim 4, wherein the fluorinated polyamic acid is a polymer represented by Formula 9 or Formula 10, and
the fluorinated polyimide is a polymer represented by Formula 11 or Formula 12: 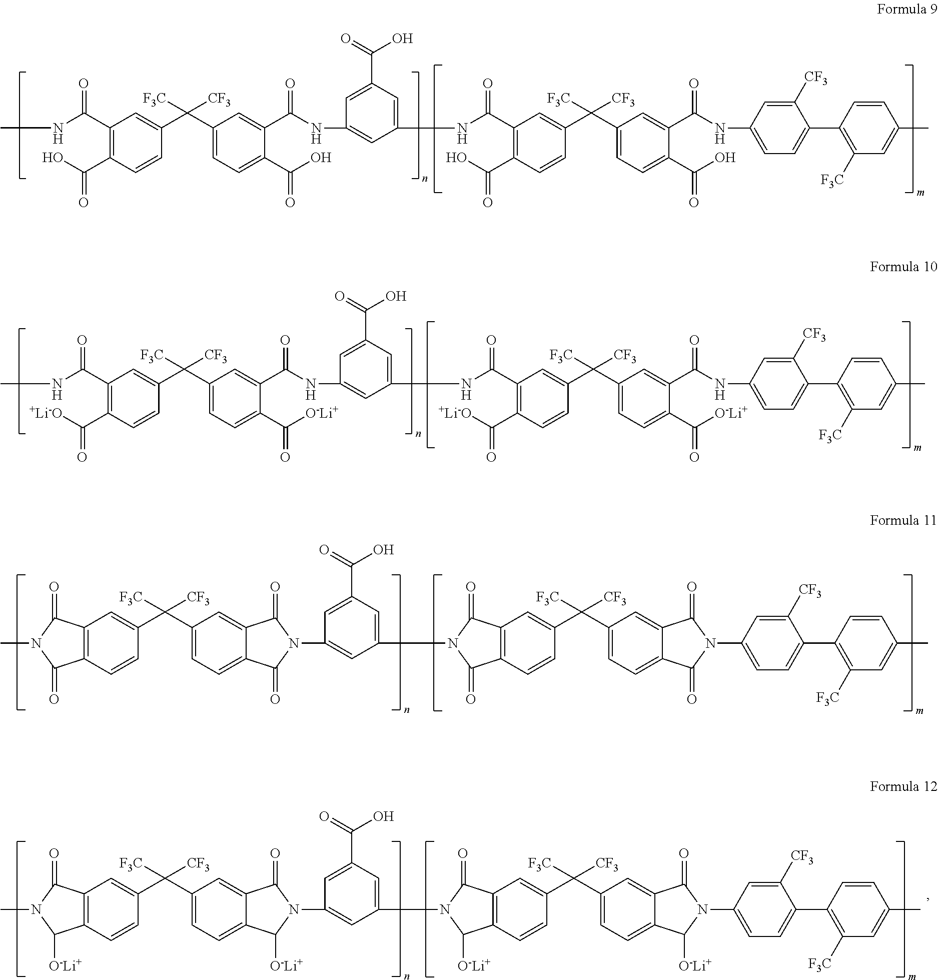
wherein, n and m each indicate a mole fraction within a repeating unit and satisfy 0<n≤1, 0≤m<1, and n+m=1.

9. The anode as claimed in claim 3, wherein a weight ratio of the first polymer to the second polymer is about 50:50 to about 99:1.

10. The anode as claimed in claim 1, wherein the protective layer comprises a cross-linked polymer of a polyvinyl alcohol and a polymer represented by Formula 9 or Formula 10:

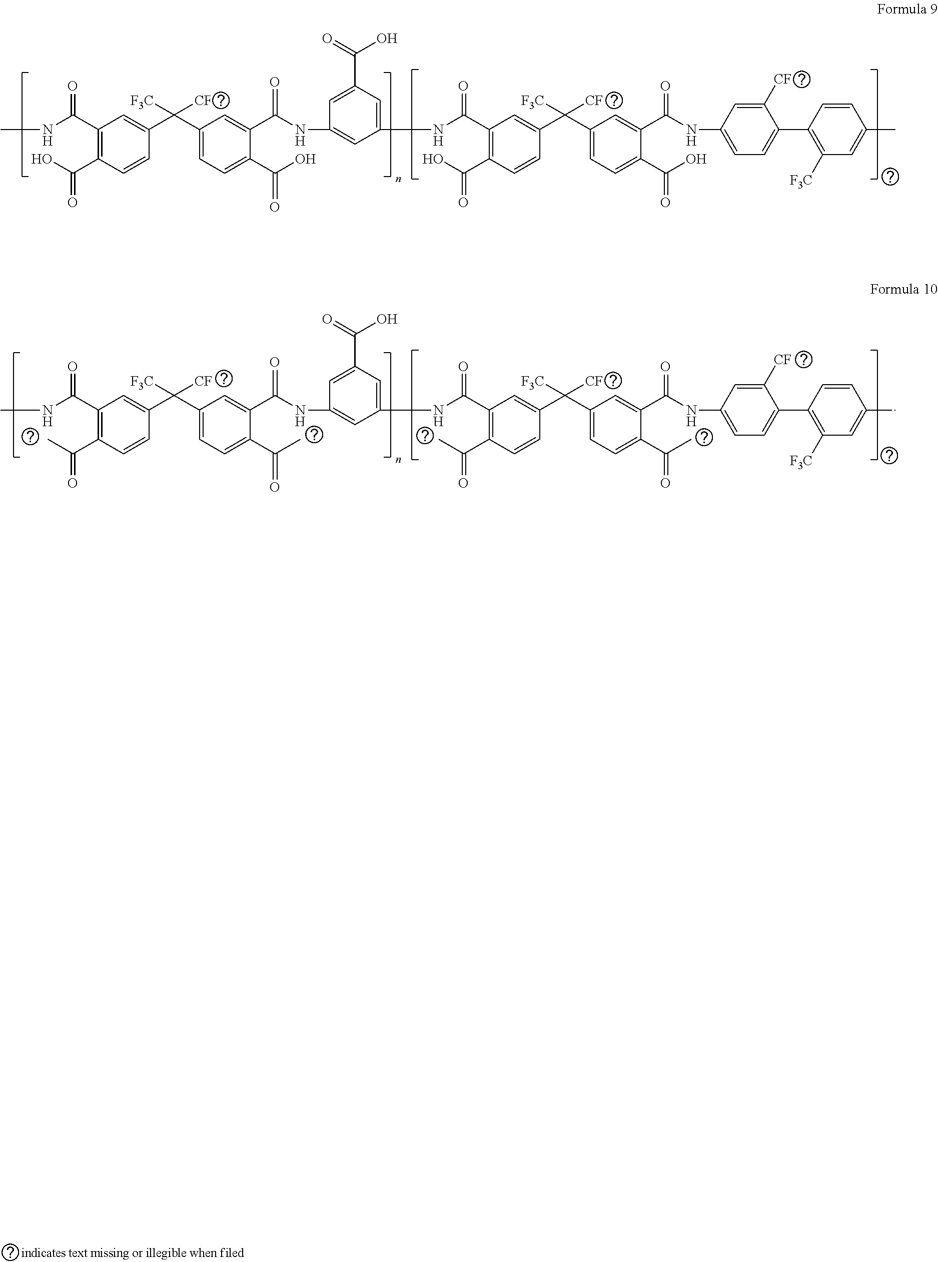

11. The anode as claimed in claim 1, wherein the protective layer further comprises a lithium salt, and
a thickness of the protective layer is about 1 micrometer (μm) to about 10 μm.

12. The anode as claimed in claim 1, wherein the anode comprises the anode active material layer that comprises lithium metal foil, lithium metal powder, lithium alloy foil, lithium alloy powder, or a combination thereof, and
wherein the lithium alloy foil and the lithium alloy powder each comprise a lithium alloy comprising lithium and a first metal, and
the first metal comprises indium (In), silicon (Si), gallium (Ga), tin (Sn), aluminum (Al), Titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel (Ni), iron (Fe), cobalt (Co), chromium (Cr), cesium (Cs), sodium (Na), potassium (K), calcium (Ca), yttrium (Y), bismuth (Bi), tantalum (Ta), hafnium (Hf), barium (Ba), vanadium (V), strontium (St), lanthanum (La), or a combination thereof.

13. The anode as claimed in claim 1, wherein the anode active material layer comprises: a carbon-based compound; a mixture of a carbon-based material and at least one of a first metal; a composite of the carbon-based material and at least one of the first metal; or a combination thereof,
the carbon-based material comprises amorphous carbon having an average particle diameter in a range of about 10 nanometer (nm) to about 100 nm, and at least one of carbon black, carbon nanotubes, carbon nanofibers, fullerene, activated carbon, carbon fibers, or a combination thereof, and
the first metal comprises indium (In), silicon (Si), gallium (Ga), tin (Sn), aluminum (Al), Titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel (Ni), iron (Fe), cobalt (Co), chromium (Cr), cesium (Cs), sodium (Na), potassium (K), calcium (Ca), yttrium (Y), bismuth (Bi), tantalum (Ta), hafnium (Hf), barium (Ba), vanadium (V), strontium (St), lanthanum (La), or a combination thereof.

14. The anode as claimed in claim 1, wherein the anode comprises the anode active material layer, and the anode has a structure in which the anode current collector, the anode active material layer, and the protective layer are sequentially arranged, and
the anode further comprises a lithium metal layer on a surface of the protective layer that is not adjacent to the anode active material layer of the protective layer.

15. A lithium metal battery, the lithium metal battery comprising:
a cathode;
the anode as claimed in claim 1; and
an electrolyte between the cathode and the anode.

16. The lithium metal battery as claimed in claim 15, wherein the electrolyte comprises a liquid electrolyte, a solid electrolyte, a gel electrolyte, or a combination thereof,
the solid electrolyte comprises an oxide-based solid electrolyte, a sulfide-based solid electrolyte, a polymer solid electrolyte, or a combination thereof, and
the gel electrolyte comprises a polymer gel electrolyte.

17. The lithium metal battery as claimed in claim 15, further comprising a separator.

18. The lithium metal battery as claimed in claim 15, wherein the cathode comprises a cathode current collector and a cathode active material layer,
at least one of the cathode current collector or the anode current collector comprises a base film and a metal layer on at least one side of the base film,
the base film comprises a polymer, the polymer comprising polyethylene terephthalate (PET), polyethylene (PE), polypropylene (PP), polybutylene terephthalate (PBT), polyimide (PI), or a combination thereof, and
the metal layer comprises indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

19. A method of preparing a lithium metal battery, the method comprising:
preparing an anode current collector;
preparing a composition;
applying and drying the composition onto the anode current collector to form a protective layer, the composition comprising a first polymer comprising a hydroxyl group, and i) boric acid (H₃BO₃), ii) a hydrate of boron oxide (B₂O₃) and water, or iii) a combination thereof;
preparing an electrolyte;
preparing a cathode; and
preparing an assembly by stacking the anode current collector, the electrolyte, and the cathode.

20. The method as claimed in claim 19, wherein the composition further comprises a second polymer having a functional group crosslinkable with the first polymer comprising a hydroxyl group.
